(19) United States
(12) Patent Application Publication
(10) Pub. No.: US 2022/0295116 A1
(43) Pub. Date: Sep. 15, 2022

(54) CONVOLUTIONAL NEURAL NETWORK LOOP FILTER BASED ON CLASSIFIER

(71) Applicant: Intel Corporation, Santa Clara, CA (US)

(72) Inventors: Shoujiang MA, Shanghai (CN); Xiaoran FANG, Shanghai (CN); Hujun YIN, Saratoga, CA (US); Rongzhen YANG, Shanghai (CN)

(73) Assignee: Intel Corporation, Santa Clara, CA (US)

(21) Appl. No.: 17/626,778

(22) PCT Filed: Sep. 20, 2019
(86) PCT No.: PCT/CN2019/106875

§ 371 Date: Jan. 12, 2022

(51) Int. Cl. H04N 19/82; H04N 19/136; H04N 19/117; H04N 19/124; H04N 19/186; H04N 19/182

(52) U.S. Cl. CPC H04N 19/82; H04N 19/136; H04N 19/117; H04N 19/124; H04N 19/186; H04N 19/182

(57) ABSTRACT

Techniques related to convolutional neural network based loop filtering for video coding are discussed and include training a convolutional neural network loop filter for each of multiple classifications into which each region of a reconstructed video frame corresponding to input video are classified and selecting a subset of the trained convolutional neural network loop filter for use in coding the input video.

### BACKGROUND

In video compression/decompression (codec) systems, compression efficiency and video quality are important performance criteria. For example, visual quality is an important aspect of the user experience in many video applications and compression efficiency impacts the amount of memory storage needed to store video files and/or the amount of bandwidth needed to transmit and/or stream video content. For example, a video encoder compresses video information so that more information can be sent over a given bandwidth or stored in a given memory space or the like. The compressed signal or data may then be decoded via a decoder that decodes or decompresses the signal or data for display to a user. In most implementations, higher visual quality with greater compression is desirable.

Loop filtering is used in video codecs to improve the quality (both objective and subjective) of reconstructed video. Such loop filtering may be applied at the end of frame reconstruction. There are different types of in-loop filters such as deblocking filters (DBF), sample adaptive offset (SAO) filters, and adaptive loop filters (ALF) that address different aspects of video reconstruction artifacts to improve the final quality of reconstructed video. The filters can be linear or non-linear, fixed or adaptive and multiple filters may be used alone or together.

There is an ongoing desire to improve such filtering (either in loop or out of loop) for further quality improvements in the reconstructed video and/or in compression. It is with respect to these and other considerations that the present improvements have been needed. Such improvements may become critical as the desire to compress and transmit video data becomes more widespread.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1A is a block diagram illustrating an example video encoder 100 having an in loop convolutional neural network loop filter;

FIG. 1B is a block diagram illustrating an example video decoder 150 having an in loop convolutional neural network loop filter;

FIG. 2A is a block diagram illustrating an example video encoder 200 having an out of loop convolutional neural network loop filter;

FIG. 2B is a block diagram illustrating an example video decoder 150 having an out of loop convolutional neural network loop filter;

FIG. 3 is a schematic diagram of an example convolutional neural network loop filter for generating filtered luma reconstructed pixel samples;

FIG. 4 is a schematic diagram of an example convolutional neural network loop filter for generating filtered chroma reconstructed pixel samples;

FIG. 5 is a schematic diagram of packing, convolutional neural network loop filter application, and unpacking for generating filtered luma reconstructed pixel samples;

FIG. 6 illustrates a flow diagram of an example process for the classification of regions of one or more video frames, training multiple convolutional neural network loop filters using the classified regions, selection of a subset of the multiple trained convolutional neural network loop filters, and quantization of the selected subset;

FIG. 7 illustrates a flow diagram of an example process for the classification of regions of one or more video frames using adaptive loop filter classification and pair sample extension for training convolutional neural network loop filters;

FIG. 8 illustrates an example group of pictures for selection of video frames for convolutional neural network loop filter training;

FIG. 9 illustrates a flow diagram of an example process for training multiple convolutional neural network loop filters using regions classified based on ALF classifications, selection of a subset of the multiple trained convolutional neural network loop filters, and quantization of the selected subset;

FIG. 10 is a flow diagram illustrating an example process for selecting a subset of convolutional neural network loop filters from convolutional neural network loop filters candidates;

FIG. 11 is a flow diagram illustrating an example process for generating a mapping table that maps classifications to selected convolutional neural network loop filter or skip filtering;

FIG. 12 is a flow diagram illustrating an example process for determining coding unit level flags for use of convolutional neural network loop filtering or to skip convolutional neural network loop filtering;

FIG. 13 is a flow diagram illustrating an example process for performing decoding using convolutional neural network loop filtering;

FIG. 14 is a flow diagram illustrating an example process for video coding including convolutional neural network loop filtering;

FIG. 15 is an illustrative diagram of an example system for video coding including convolutional neural network loop filtering;

FIG. 16 is an illustrative diagram of an example system; and

FIG. 17 illustrates an example device, all arranged in accordance with at least some implementations of the present disclosure.

### DETAILED DESCRIPTION

One or more embodiments or implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in architectures such as system-on-a-chip (SoC) architectures for example, implementation of the techniques and/or arrangements described herein are not restricted to particular architectures and/or computing systems and may be implemented by any architecture and/or computing system for similar purposes. For instance, various architectures employing, for example, multiple integrated circuit (IC) chips and/or packages, and/or various computing devices and/or consumer electronic (CE) devices such as set top boxes, smart phones, etc., may implement the techniques and/or arrangements described herein. Further, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, firmware, software, or any combination thereof. The material disclosed herein may also be implemented as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

References in the specification to “one implementation”, “an implementation”, “an example implementation”, etc., indicate that the implementation described may include a particular feature, structure, or characteristic, but every embodiment may not necessarily include the particular feature, structure, or characteristic. Moreover, such phrases are not necessarily referring to the same implementation. Further, when a particular feature, structure, or characteristic is described in connection with an embodiment, it is submitted that it is within the knowledge of one skilled in the art to effect such feature, structure, or characteristic in connection with other implementations whether or not explicitly described herein.

The terms “substantially,” “close,” “approximately,” “near,” and “about,” generally refer to being within +/−10% of a target value. For example, unless otherwise specified in the explicit context of their use, the terms “substantially equal,” “about equal” and “approximately equal” mean that there is no more than incidental variation between among things so described. In the art, such variation is typically no more than +/−10% of a predetermined target value. Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

Methods, devices, apparatuses, computing platforms, and articles are described herein related to convolutional neural network loop filtering for video encode and decode.

As described above, it may be advantageous to improve loop filtering for improved video quality and/or compression. As discussed herein, some embodiments include application of convolutional neural networks in video coding loop filter applications. Convolutional neural network (CNNs) may improve the quality of reconstructed video or video coding efficiency. For example, a CNN may act as a nonlinear loop filter to improve the quality of reconstructed video or video coding efficiency. For example, a CNN may be applied as either an out of loop filter stage or as an in-loop filter stage. As used herein, a CNN applied in such a context is labeled as a convolutional neural network loop filter (CNNLF). As used herein, the term CNN or CNNLF indicates a deep learning neural network based model employing one or more convolutional layers. As used herein, the term convolutional layer indicates a layer of a CNN that provides a convolutional filtering as well as other optional related operations such as rectified linear unit (ReLU) operations, pooling operations, and/or local response normalization (LRN) operations. In an embodiment, each convolutional layer includes at least convolutional filtering operations. The output of a convolutional layer may be characterized as a feature map.

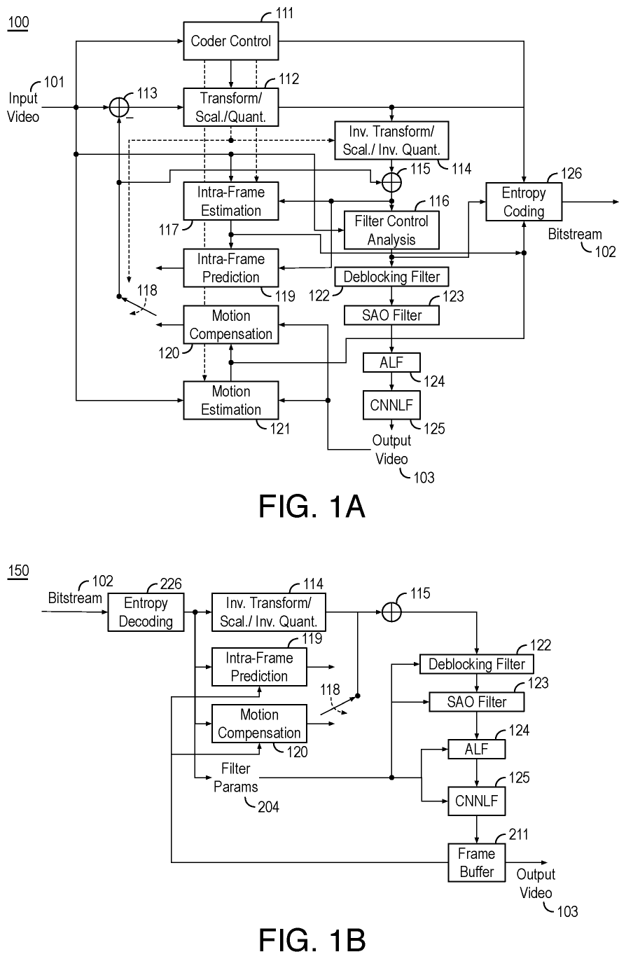

FIG. 1A is a block diagram illustrating an example video encoder 100 having an in loop convolutional neural network loop filter 125, arranged in accordance with at least some implementations of the present disclosure. As shown, video encoder 100 includes a coder controller 111, a transform, scaling, and quantization module 112, a differencer 113, an inverse transform, scaling, and quantization module 114, an adder 115, a filter control analysis module 116, an intra-frame estimation module 117, a switch 118, an intra-frame prediction module 119, a motion compensation module 120, a motion estimation module 121, a deblocking filter 122, an SAO filter 123, an adaptive loop filter 124, in loop convolutional neural network loop filter (CNNLF) 125, and an entropy coder 126.

Video encoder 100 operates under control of coder controller 111 to encode input video 101, which may include any number of frames in any suitable format, such as a YUV format or YCbCr format, frame rate, resolution, bit depth, etc. Input video 101 may include any suitable video frames, video pictures, sequence of video frames, group of pictures, groups of pictures, video data, or the like in any suitable resolution. For example, the video may be video graphics array (VGA), high definition (HD), Full-HD (e.g., 1080p), 4K resolution video, 8K resolution video, or the like, and the video may include any number of video frames, sequences of video frames, pictures, groups of pictures, or the like. Techniques discussed herein are discussed with respect to video frames for the sake of clarity of presentation. However, such frames may be characterized as pictures, video pictures, sequences of pictures, video sequences, etc. The terms frame and picture are used interchangeably herein. For example, a frame of color video data may include a luminance plane or component and two chrominance planes or components at the same or different resolutions with respect to the luminance plane. Input video 101 may include pictures or frames that may be divided into blocks of any size, which contain data corresponding to blocks of pixels. Such blocks may include data from one or more planes or color channels of pixel data.

Differencer 113 differences original pixel values or samples from predicted pixel values or samples to generate residuals. The predicted pixel values or samples are generated using intra prediction techniques using intra-frame estimation module 117 (to determine an intra mode) and intra-frame prediction module 119 (to generate the predicted pixel values or samples) or using inter prediction techniques using motion estimation module 121 (to determine inter mode, reference frame(s) and motion vectors) and motion compensation module 120 (to generate the predicted pixel values or samples).

The residuals are transformed, scaled, and quantized by transform, scaling, and quantization module 112 to generate quantized residuals (or quantized original pixel values if no intra or inter prediction is used), which are entropy encoded into bitstream 102 by entropy coder 126. Bitstream 102 may be in any format and may be standards compliant with any suitable codec such as H.264 (Advanced Video Coding, AVC), H.265 (High Efficiency Video Coding, HEVC), H.266 (Versatile Video Coding, VCC), etc. Furthermore, bitstream 102 may have any indicators, data, syntax, etc. discussed herein. The quantized residuals are decoded via a local decode loop including inverse transform, scaling, and quantization module 114, adder 115 (which also uses the predicted pixel values or samples from intra-frame estimation module 117 and/or motion compensation module 120, as needed), deblocking filter 122, SAO filter 123, adaptive loop filter 124, and CNNLF 125 to generate output video 103 which may have the same format as input video 101 or a different format (e.g., resolution, frame rate, bit depth, etc.). Notably, the discussed local decode loop performs the same functions as a decoder (discussed with respect to FIG. 1B) to emulate such a decoder locally. In the example of FIG. 1A, the local decode loop includes CNNLF 125 such that the output video is used by motion estimation module 121 and motion compensation module 120 for inter prediction. The resultant output video may be stored to a frame buffer for use by intra-frame estimation module 117, intra-frame prediction module 119, motion estimation module 121, and motion compensation module 120 for prediction. Such processing is repeated for any portion of input video 101 such as coding tree units (CTUs), coding units (CUs), transform units (TUs), etc. to generate bitstream 102, which may be decoded to produce output video 103.

Notably, coder controller 111, transform, scaling, and quantization module 112, differencer 113, inverse transform, scaling, and quantization module 114, adder 115, filter control analysis module 116, intra-frame estimation module 117, switch 118, intra-frame prediction module 119, motion compensation module 120, motion estimation module 121, deblocking filter 122, SAO filter 123, adaptive loop filter 124, and entropy coder 126 operate as known by one skilled in the art to code input video 101 to bitstream 102.

FIG. 1B is a block diagram illustrating an example video decoder 150 having in loop convolutional neural network loop filter 125, arranged in accordance with at least some implementations of the present disclosure. As shown, video decoder 150 includes an entropy decoder 226, inverse transform, scaling, and quantization module 114, adder 115, intra-frame prediction module 119, motion compensation module 120, deblocking filter 122, SAO filter 123, adaptive loop filter 124, CNNLF 125, and a frame buffer 211.

Notably, the like components of video decoder 150 with respect to video encoder 100 operate in the same manner to decode bitstream 102 to generate output video 103, which in the context of FIG. 1B may be output for presentation to a user via a display and used by motion compensation module 120 for prediction. For example, entropy decoder 226 receives bitstream 102 and entropy decodes it to generate quantized pixel residuals (and quantized original pixel values or samples), intra prediction indicators (intra modes, etc.), inter prediction indicators (inter modes, reference frames, motion vectors, etc.), and filter parameters 204 (e.g., filter selection, filter coefficients, CNN parameters etc.). Inverse transform, scaling, and quantization module 114 receives the quantized pixel residuals (and quantized original pixel values or samples) and performs inverse quantization, scaling, and inverse transform to generate reconstructed pixel residuals (or reconstructed pixel samples). In the case of intra or inter prediction, the reconstructed pixel residuals are added with predicted pixel values or samples via adder 115 to generate reconstructed CTUs, CUs, etc. that constitute a reconstructed frame. The reconstructed frame is then deblock filtered (to smooth edges between blocks) by deblocking filter 122, sample adaptive offset filtered (to improve reconstruction of the original signal amplitudes) by SAO filter 123, adaptive loop filtered (to further improve objective and subjective quality) by adaptive loop filter 124, and filtered by CNNFL 125 (as discussed further herein) to generate output video 103. Notably, the application of CNNFL 125 is in loop as the resultant filtered video samples are used in inter prediction.

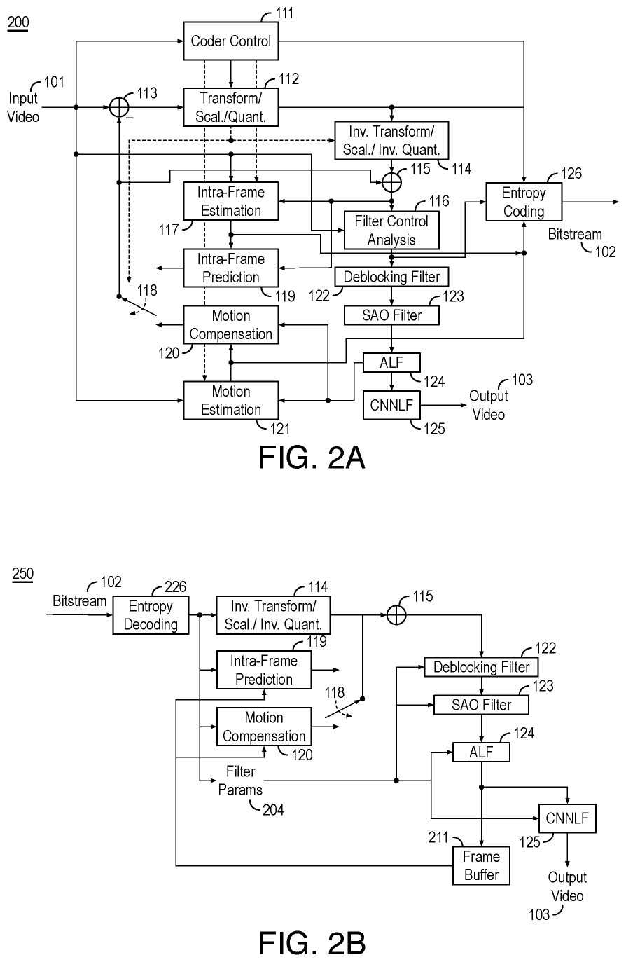

FIG. 2A is a block diagram illustrating an example video encoder 200 having an out of loop convolutional neural network loop filter 125, arranged in accordance with at least some implementations of the present disclosure. As shown, video encoder 200 includes coder controller 111, transform, scaling, and quantization module 112, differencer 113, inverse transform, scaling, and quantization module 114, adder 115, filter control analysis module 116, intra-frame estimation module 117, switch 118, intra-frame prediction module 119, motion compensation module 120, motion estimation module 121, deblocking filter 122, SAO filter 123, adaptive loop filter 124, CNNLF 125, and entropy coder 126.

Such components operate in the same fashion as discussed with respect to video encoder 100 with the exception that CNNLF 125 is applied out of loop such that the resultant reconstructed video samples from adaptive loop filter 124 are used for inter prediction and the CNNLF 125 is thereafter applied to improve the video quality of output video 103 (although it is not used for inter prediction).

FIG. 2B is a block diagram illustrating an example video decoder 250 having an out of loop convolutional neural network loop filter 125, arranged in accordance with at least some implementations of the present disclosure. As shown, video decoder 250 includes entropy decoder 226, inverse transform, scaling, and quantization module 114, adder 115, intra-frame prediction module 119, motion compensation module 120, deblocking filter 122, SAO filter 123, adaptive loop filter 124, CNNLF 125, and a frame buffer 211. Such components may again operate in the same manner as discussed herein. As shown, CNNLF 125 is again out of loop such that the resultant reconstructed video samples from adaptive loop filter 124 are used for prediction by intra-frame prediction module 119 and motion compensation module 120 while CNNLF 125 is further applied to generate output video 103 and also prior to presentation to a viewer via a display.

As shown in FIGS. 1A, 1B, 2A, 2B, a CNN (i.e., CNNLF 125) may be applied as an out of loop filter stage (FIG. 2A, 2B) or an in-loop filter stage (FIGS. 1A, 1B). The inputs of CNNLF 125 may include one or more of three kinds of data: reconstructed samples, prediction samples, and residual samples. Reconstructed samples (Reco.) are adaptive loop filter 124 output samples, prediction samples (Pred.) are inter or intra prediction samples (i.e., from intra-frame prediction module 119 or motion compensation module 120), and residual samples (Resi.) are samples after inverse quantization and inverse transform (i.e., from inverse transform, scaling, and quantization module 114). The outputs of CNNLF 125 are the restored reconstructed samples.

The discussed techniques provide a convolutional neural network loop filter (CNNLF) based on a classifier, such as, for example, a current ALF classifier as provided in AVC, HEVC, VCC, or other codec. In some embodiments, a number CNN loop filters (e.g., 25 in CNNLFs in the context of ALF classification) are trained for luma and chroma respectively (e.g., 25 luma and 25 chroma CNNLFs, one for each of the 25 classifications) using the current video sequence as classified by the ALF classifier into subgroups (e.g., 25 subgroups). For example, each CNN loop may be a relatively small 2 layer CNN with a total of about 732 parameters. A particular number, such as three, CNN loop filters are selected from the 25 trained filters based on, for example, a maximum gain rule using a greedy algorithm. Such CNNLF selection may also be adaptive such that a maximum number of CNNLFs (e.g., 3 may be selected) but fewer are used if the gain from such CNNLFs is insufficient with respect to the cost of sending the CNNLF parameters. In some embodiments, the classifier for CNNLFs may advantageously re-use the ALF classifier (or other classifier) for improved encoding efficiency and reduction of additional signaling overhead since the index of selected CNNLF for each small block is not needed in the coded stream (i.e., bitstream 102). The weights of the trained set of CNNLFs (after optional quantization) are signaled in bitstream 102 via, for example, the slice header of I frames of input video 101.

In some embodiments, multiple small CNNLFs (CNNs) are trained at an encoder as candidate CNNLFs for each subgroup of video blocks classified using a classifier such as the ALF classifier. For example, each CNNLF is trained using those blocks (of a training set of one or more frames) that are classified into the particular subgroup of the CNNLF. That is, blocks classified in classification 1 are used to train CNNLF 1, blocks classified in classification 2 are used to train CNNLF 2, blocks classified in classification x are used to train CNNLF x, and so on to provide a number (e.g., N) trained CNNLFs. Up to a particular number (e.g., M) CNNLFs are then chosen based on PSNR performance of the CNNLFs (on the training set of one or more frames). As discussed further herein, fewer or no CNNLFs may be chosen if the PSNR performance does not warrant the overhead of sending the CNNLF parameters. The encoder then performs encoding of frames utilizing the selected CNNLFs to determine a classification (e.g., ALF classification) to CNNLF mapping table that indicates the relationship between classification index (e.g., ALF index) and CNNLF. That is, for each frame, blocks of the frame are classified such that each block has a classification (e.g., up to 25 classifications) and then each classification is mapped to a particular one of the CNNLFs such that a many (e.g., 25) to few (e.g., 3) mapping from classification to CNNLF is provided. Such mapping may also map to no use of a CNNLF. The mapping table is encoded in the bitstream by entropy coder 126. The decoder receives the selected CNNLF models mapping table and performs CNNLF inference in accordance with the ALF mapping table such that luma and chroma components use the same ALF mapping table. Furthermore, such CNNLF processing may be flagged as ON or OFF for CTUs (or other coding unit levels) via CTU flags encoded by entropy coder 126 and decoded and implemented the decoder.

The techniques discussed herein provide for CNNLF using a classifier such as an ALF classifier for substantial reduction of overhead of CNNLF switch flags as compared to other CNNLF techniques such as switch flags based on coding units. In some embodiments, 25 candidate CNNLFs by ALF classification are trained with the input data (for CNN training and inference) being extended from 4×4 to 12×12 (or using other sizes for the expansion) to attain a larger view field for improved training and inference. Furthermore, the first convolution layer of the CNNLFs may utilize a larger kernel size for an increased receptive field.

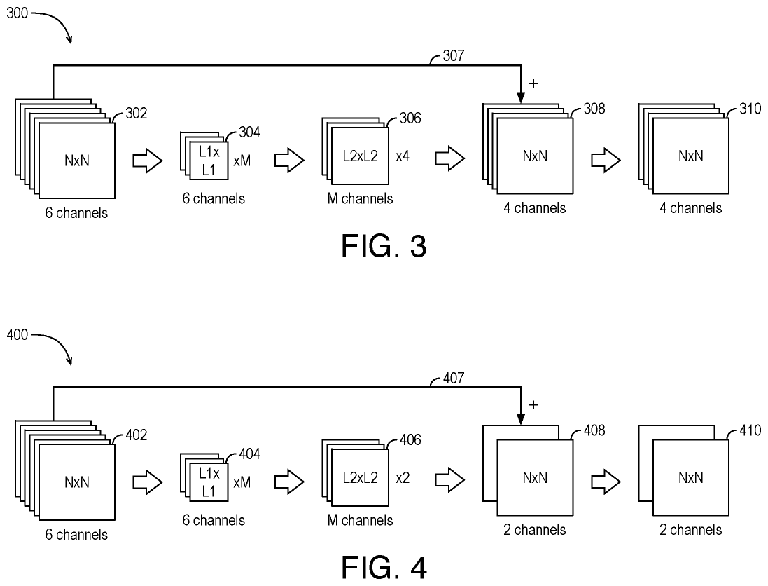

FIG. 3 is a schematic diagram of an example convolutional neural network loop filter 300 for generating filtered luma reconstructed pixel samples, arranged in accordance with at least some implementations of the present disclosure. As shown in FIG. 3, convolutional neural network loop filter (CNNLF) 300 provides a CNNLF for luma and includes an input layer 302, hidden convolutional layers 304, 306, a skip connection layer 308 implemented by a skip connection 307, and a reconstructed output layer 310. Notably, multiple versions of CNNLF 300 are trained, one for each classification of multiple classifications of a reconstructed video frame, as discussed further herein, to generate candidate CNNLFs. The candidate CNNLFs will then be evaluated and a subset thereof are selected for encode. Such multiple CNNLFs may have the same formats or they may be different. In the context of FIG. 3, CNNLF 300 illustrates any CNNLF applied herein for training or inference during coding.

As shown, in some embodiments, CNNLF 300 includes only two hidden convolutional layers 304, 306. Such a CNNLF architecture provides for a compact CNNLF for transmission to a decoder. However, any number of hidden layers may be used. CNNLF 300 receives reconstructed video frame samples and outputs filtered reconstructed video frame (e.g., CNNLF loop filtered reconstructed video frame). Notably, in training, each CNNLF 300 uses a training set of reconstructed video frame samples from a particular classification (e.g., those regions classified into the particular classification for which CNNLF 300 is being trained) paired with actual original pixel samples (e.g., the ground truth or labels used for training). Such training generates CNNLF parameters that are transmitted for use by a decoder (after optional quantization). In inference, each CNNLF 300 is applied to reconstructed video frame samples to generate filtered reconstructed video frame samples. As used herein the terms reconstructed video frame sample and filtered reconstructed video frame samples are relative to a filtering operation therebetween. Notably, the input reconstructed video frame samples may have also been previously filtered (e.g., deblocking filtered, SAO filtered, and adaptive loop filtered).

In some embodiments, packing and/or unpacking operations are performed at input layer 302 and output layer 304. For packing luma (Y) blocks, for example, to form input layer 302, a luma block of 2N×2N to be processed by CNNLF 300 may be 2×2 subsampled to generate four channels of input layer 302, each having a size of N×N. For example, for each 2×2 sub-block of the luma block, a particular pixel sample (upper left, upper right, lower left, lower right) is selected and provided for a particular channel. Furthermore, the channels of input layer 302 may include two N×N channels each corresponding to a chroma channel of the reconstructed video frame. Notably, such chroma may have a reduced resolution by 2×2 with respect to the luma channel (e.g., in 4:2:0 format). For example, CNNLF 300 is for luma data filtering but chroma input is also used for increased inference accuracy.

As shown, input layer 302 and output layer 310 may have an image block size of N×N, which may be any suitable size such as 4×4, 8×8, 16×16, or 32×32. In some embodiments, the value of N is determined based on a frame size of the reconstructed video frame. In an embodiment, in response to a larger frame size (e.g., 2K, 4K, or 1080P), a block size, N, of 16 or 32 may be selected and in response to a smaller frame size (e.g., anything less than 2K), a block size, N, of 8, 4, or 2 may be selected. However, as discussed, any suitable block sizes may be implemented.

As shown, hidden convolutional layer 304 applies any number, M, of convolutional filters of size L1×L1 to input layer 302 to generate feature maps having M channels and any suitable size. The filter size implemented by hidden convolutional layer 304 may be any suitable size such as 1×1 or 3×3 (e.g., L1=1 or L1=3). In an embodiment, hidden convolutional layer 304 implements filters of size 3×3. The number of filters M may be any suitable number such as 8, 16, or 32 filters. In some embodiments, the value of M is also determined based on a frame size of the reconstructed video frame. In an embodiment, in response to a larger frame size (e.g., 2K, 4K, or 1080P), a filter number, M, of 16 or 32 may be selected and in response to a smaller frame size (e.g., anything less than 2K), a filter number, M, of 16 or 8 may be selected.

Furthermore, hidden convolutional layer 306 applies four convolutional filters of size L2×L2 to the feature maps generate feature maps that are added to input layer 302 via skip connection 307 to generate output layer 310 having four channels and a size of N×N. The filter size implemented by hidden convolutional layer 306 may be any suitable size such as 1×1, 3×3, or 5×5 (e.g., L2=1, L2=3, or L2=5). In an embodiment, hidden convolutional layer 304 implements filters of size 3×3. Hidden convolutional layers 304 and/or hidden convolutional layer 306 may also implement rectified linear units (e.g., activation functions). In an embodiment, hidden convolutional layer 304 includes a rectified linear unit after each filter while hidden convolutional layer 306 does not include rectified linear unit and has a direct connection to skip connection layer 308.

At output layer 310, unpacking of the channels may be performed to generate a filtered reconstructed luma block having the same size as the input reconstructed luma block (i.e., 2N×2N). In an embodiment, the unpacking mirrors the operation of the discussed packing such that each channel represents a particular location of a 2×2 block of the filtered reconstructed luma block (e.g., top left, top right, bottom left, bottom right). Such unpacking may then provide for each of such locations of the filtered reconstructed luma block being populated according to the channels of output layer 310.

FIG. 4 is a schematic diagram of an example convolutional neural network loop filter 400 for generating filtered chroma reconstructed pixel samples, arranged in accordance with at least some implementations of the present disclosure. As shown in FIG. 4, convolutional neural network loop filter (CNNLF) 400 provides a CNNLF for both chroma channels and includes an input layer 402, hidden convolutional layers 404, 406, a skip connection layer 408 implemented by a skip connection 407, and a reconstructed output layer 410. As discussed with respect to CNNLF 300, multiple versions of CNNLF 400 are trained, one for each classification of multiple classifications of a reconstructed video frame to generate candidate CNNLFs, which are evaluated for selection of a subset thereof for encode. In some embodiments, for each classification a single luma CNNLF 300 and a single chroma CNNLF 400 are trained and evaluated together. Use of a singular CNNLF herein as corresponding to a particular classification may then indicate a single luma CNNLF or both a luma CNNLF and a chroma CNNLF, which are jointly identified as a CNNLF for reconstructed pixel samples.

As shown, in some embodiments, CNNLF 400 includes only two hidden convolutional layers 404, 406, which may have any characteristics as discussed with respect to hidden convolutional layers 304, 306. As with CNNLF 300, however, CNNLF 400 may implement any number of hidden convolutional layers having any features discussed herein. In some embodiments, CNNLF 300 and CNNLF 400 employ the same hidden convolutional layer architectures and, in some embodiments, they are different. In training, each CNNLF 400 uses a training set of reconstructed video frame samples from a particular classification paired with actual original pixel samples to determine CNNLF parameters that are transmitted for use by a decoder (after optional quantization). In inference, each CNNLF 400 is applied to reconstructed video frame samples to generate filtered reconstructed video frame samples (i.e., chroma samples).

As with implementation of CNNLF 300, packing operations are performed at input layer 402 of CNNLF 400. Such packing operations may be performed in the same manner as discussed with respect to CNNLF 300 such that input layer 302 and input layer 402 are the same. However, no unpacking operations are needed with respect to output layer 410 since output layer 410 provides N×N resolution (matching chroma resolution, which is one-quarter the resolution of luma) and 2 channels (one for each chroma channel).

As discussed above, input layer 402 and output layer 410 may have an image block size of N×N, which may be any suitable size such as 4×4, 8×8, 16×16, or 32×32 and in some embodiments is responsive to the reconstructed frame size. Hidden convolutional layer 404 applies any number, M, of convolutional filters of size L1×L1 to input layer 402 to generate feature maps having M channels and any suitable size. The filter size implemented by hidden convolutional layer 404 may be any suitable size such as 1×1 or 3×3 (with 3×3 being advantageous) and the number of filters M may be any suitable number such as 8, 16, or 32 filters, which may again be responsive to the reconstructed frame size. Hidden convolutional layer 406 applies two convolutional filters of size L2×L2 to the feature maps generate feature maps that are added to input layer 402 via skip connection 407 to generate output layer 410 having two channels and a size of N×N. The filter size implemented by hidden convolutional layer 406 may be any suitable size such as 1×1, 3×3, or 5×5 (with 3×3 being advantageous). In an embodiment, hidden convolutional layer 404 includes a rectified linear unit after each filter while hidden convolutional layer 406 does not include rectified linear unit and has a direct connection to skip connection layer 408.

As discussed, output layer 410 does not require unpacking and may be used directly as filtered reconstructed chroma blocks (e.g., channel 1 being for Cb and channel 2 being for Cr).

Thereby, CNNLFs 300, 400 provide for filtered reconstructed blocks of pixel samples with CNNLF 300 (after unpacking) providing a luma block of size 2N×2N and CNNLF 400 providing corresponding chroma blocks of size N×N, suitable for 4:2:0 color compressed video.

In some embodiments, for increased accuracy, based on the reconstructed blocks of pixel samples for CNN filtering an input layer may be generated that uses expansion such that pixel samples around the block being filtered are also used for training and inference of the CNNLF.

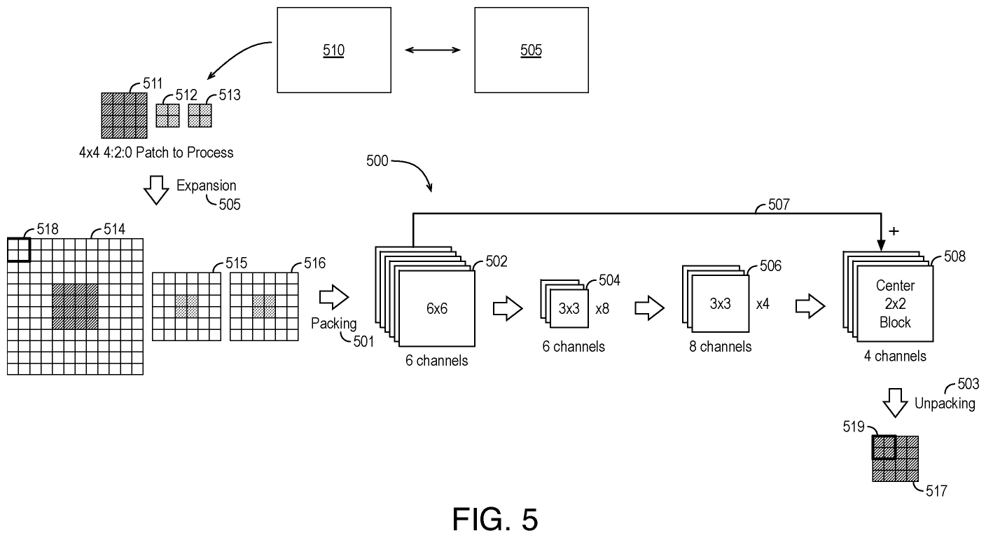

FIG. 5 is a schematic diagram of packing, convolutional neural network loop filter application, and unpacking for generating filtered luma reconstructed pixel samples, arranged in accordance with at least some implementations of the present disclosure. As shown in FIG. 5, a luma region 511 of luma pixel samples, a chroma region 512 of chroma pixel samples, and a chroma region 513 of chroma pixel samples are received for processing such that luma region 511, chroma region 512, and chroma region 513 are from a reconstructed video frame 510, which corresponds to an original video frame 505. For example, original video frame 505 may be a video frame of input video 101 and reconstructed video frame 510 may be a video frame after reconstruction as discussed above. For example, video frame 510 may be output from ALF 124.

In the illustrated embodiment, luma region 511 is 4×4 pixels, chroma region 512 (i.e., a Cb chroma channel) is 2×2 pixels, and chroma region 513 (i.e., a Cr chroma channel) is 2×2 pixels. However, any region sizes may be used. Notably, packing operation 501, application of a CNNLF 500, and unpacking operation 503 generate a filtered luma region 517 having the same size (i.e., 4×4 pixels) as luma region 511.

As shown, in some embodiments, each of luma region 511, chroma region 512, and chroma region 513 are first expanded to expanded luma region 514, expanded chroma region 515, and expanded chroma region 516, respectively such that expanded luma region 514, expanded chroma region 515, and expanded chroma region 516 bring in additional pixels for improved training and inference of CNNLF 500 such that filtered luma region 517 more faithfully emulates corresponding original pixels of original video frame 505. With respect to expanded luma region 514, expanded chroma region 515, and expanded chroma region 516, shaded pixels indicate those pixels that are being processed while un-shaded pixel indicate support pixels for the inference of the shaded pixels such that the pixels being processed are centered with respect to the support pixels.

In the illustrated embodiment, each of luma region 511, chroma region 512, and chroma region 513 are expanded by 3 in both the horizontal and vertical directions. However, any suitable expansion factor such as 2 or 4 may be implemented. As shown, using an expansion factor of 3, expanded luma region 514 has a size of 12×12, expanded chroma region 515 has a size of 6×6, and expanded chroma region 516 has a size of 6×6. Expanded luma region 514, expanded chroma region 515, and expanded chroma region 516 are then packed to form input layer 502 of CNNLF 500. Expanded chroma region 515 and expanded chroma region 516 each form one of the six channels of input layer 502 without further processing. Expanded luma region 514 is subsampled to generate four channels of input layer 502. Such subsampling may be performed using any suitable technique or techniques. In an embodiment, 2×2 regions (e.g., adjacent and non-overlapping 2×2 regions) of expanded luma region 514 such as sampling region 518 (as indicated by bold outline) are sampled such that top left pixels of the 2×2 regions make up a first channel of input layer 502, top right pixels of the 2×2 regions make up a second channel of input layer 502, bottom left pixels of the 2×2 regions make up a third channel of input layer 502, and bottom right pixels of the 2×2 regions make up a fourth channel of input layer 502. However, any suitable subsampling may be used.

As discussed with respect to CNNLF 300, CNNLF 500 (e.g., an exemplary implementation of CNNLF 300) provides inference for filtering luma regions based on expansion 505 and packing 501 of luma region 511, chroma region 512, and chroma region 513. As shown in FIG. 5, CNNLF 500 provides a CNNLF for luma and includes input layer 302, hidden convolutional layers 504, 506, and a skip connection layer 508 (or output layer 508) implemented by a skip connection 507, and a reconstructed output layer 310. Output layer 508 is the unpacked via unpacking operation 503 to generate filtered luma region 517.

Unpacking operation 503 may be performed using any suitable technique or techniques. In some embodiments, unpacking operation 503 mirrors packing operation 501. For example, with respect to packing operation performing subsampling such that 2×2 regions (e.g., adjacent and non-overlapping 2×2 regions) of expanded luma region 514 such as sampling region 518 (as indicated by bold outline) are sampled with top left pixels making a first channel of input layer 502, top right pixels making a second channel, bottom left pixels making a third channel, and bottom right pixels making a fourth channel of input layer 502, unpacking operation 503 may include placing a first channel into top left pixel locations of 2×2 regions of filtered luma region 517 (such as 2×2 region 519, which is labeled with bold outline). The 2×2 regions of filtered luma region 517 are again adjacent and non-overlapping. Although discussed with respect to a particular packing operation 501 and unpacking operation 503 for the sake of clarity, any packing and unpacking operations may be used.

In some embodiments, CNNLF 500 includes only two hidden convolutional layers 504, 506 such that hidden convolutional layer 504 implements 8 3×3 convolutional filters to generate feature maps. Furthermore, in some embodiments, hidden convolutional layer 506 implements 4 3×3 filters to generate feature maps that are added to input layer 502 to provide output layer 508. However, CNNLF 500 may implement any number of hidden convolutional layers having any suitable features such as those discussed with respect to CNNLF 300.

As discussed, CNNLF 500 provides inference (after training) for filtering luma regions based on expansion 505 and packing 501 of luma region 511, chroma region 512, and chroma region 513. In some embodiments, a CNNLF in accordance with CNNLF 500 may provide inference (after training) of chroma regions 512, 513 as discussed with respect to FIG. 4. For example, packing operation 501 may be performed in the same manner to generate the same input channel 502 and the same hidden convolutional layer 504 may be applied. However, hidden convolutional layer 506 may instead apply two filters of size 3×3 and the corresponding output layer may have 2 channels of size 2×2 that do not need to be unpacked as discussed with respect to FIG. 4.

Discussion now turns to the training of multiple CNNLFs, one for each classification of regions of a reconstructed video frame and selection of a subset of the CNNLFs thereof for use in coding.

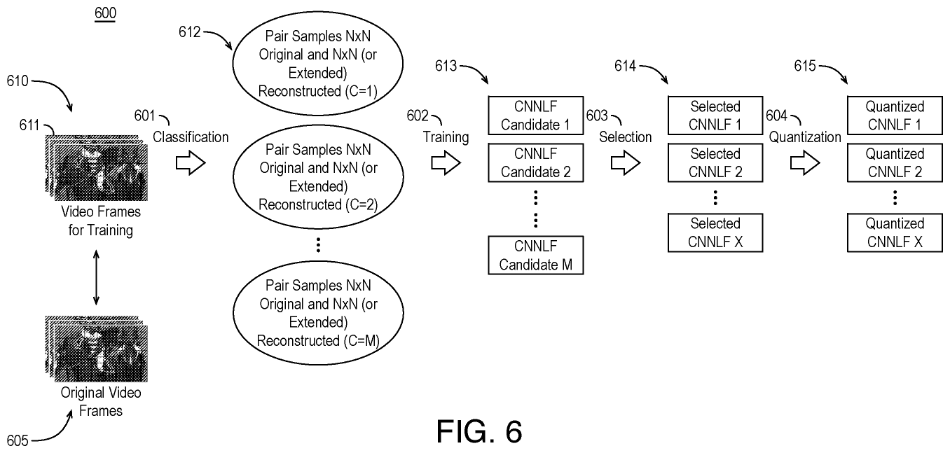

FIG. 6 illustrates a flow diagram of an example process 600 for the classification of regions of one or more video frames, training multiple convolutional neural network loop filters using the classified regions, selection of a subset of the multiple trained convolutional neural network loop filters, and quantization of the selected subset, arranged in accordance with at least some implementations of the present disclosure. As shown in FIG. 6, one or more reconstructed video frames 610, which correspond to original video frames 605, are selected for training and selecting CNNLFs. For example, original video frames 605 may be frames of video input 101 and reconstructed video frames 610 may be output from ALF 124.

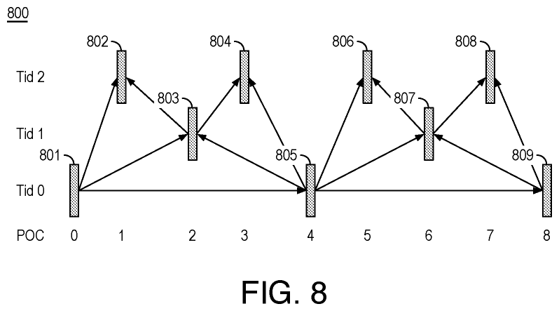

Reconstructed video frames 610 may be selected using any suitable technique or techniques such as those discussed herein with respect to FIG. 8. In some embodiments, temporal identification (ID) of a picture order count (POC) of video frames is used to select reconstructed video frames 610. For example, temporal ID frames of 0 or temporal ID frames of 0 or 1 may be used for the training and selection discussed herein. For example, the temporal ID frames may be in accordance with the VCC codec. In other examples, only I frames are used. In yet other examples, only I frames and B frames are used. Furthermore, any number of reconstructed video frames 610 may be used such as 1, 4, or 8, etc. The discussed CNNLF training, selection, and use for encode may be performed for any subset of frames of input video 101 such as a group of picture (GOP) of 8, 16, 32, or more frames. Such training, selection, and use for encode may then be repeated for each GOP instance.

As shown in FIG. 6, each of reconstructed video frames 610 are divided into regions 611. Reconstructed video frames 610 may be divided into any number of regions 611 of any size. For example, regions 611 may be 4×4 regions, 8×8 regions, 16×16 regions, 32×32 regions, 64×64 regions, or 128×128 regions. Although discussed with respect to square regions of the same size, regions 611 may be of any shape and may vary in size throughout reconstructed video frames 610. Although described as regions, such partitions of reconstructed video frames 610 may be characterized as blocks or the like.

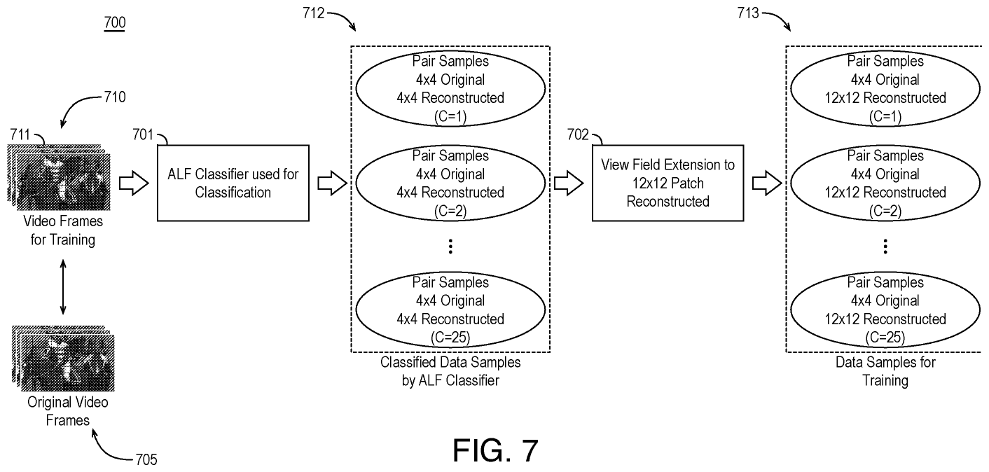

Classification operation 601 then classifies each of regions 611 into a particular classification of multiple classifications (i.e. into only one of 1−M classifications). Any number of classifications of any type may be used. In an embodiment, as discussed with respect to FIG. 7, ALF classification as defined by the VCC codec is used. In an embodiment, a coding unit size to which each of regions 611 belongs is used for classification. In an embodiment, whether or not each of regions 611 has an edge and a corresponding edge strength is used for classification. In an embodiment, a region variance of each of regions 611 is used for classification. For example, any number of classifications having suitable boundaries (for binning each of regions 611) may be used for classification.

Based on classification operation 601, paired pixel samples 612 for training are generated. For each classification, the corresponding regions 611 are used to generate pixel samples for the particular classification. For example, for classification 1 (C=1), pixel samples from those regions classified into classification 1 are paired and used for training. Similarly, for classification 2 (C=2), pixel samples from those regions classified into classification 2 are paired and used for training and for classification M (C=M), pixel samples from those regions classified into classification M are paired and used for training, and so on. As shown, paired pixel samples 612 pair N×N pixel samples (in the luma domain) from an original video frame (i.e., original pixel samples) with N×N reconstructed pixel samples from a reconstructed video frame. That is, each CNNLF is trained using reconstructed pixel samples as input and original pixel samples as the ground truth for training of the CNNLF. Notably, such techniques may attain different numbers of paired pixel samples 612 for training different CNNLFs. Also as shown in FIG. 6, in some embodiments, the reconstructed pixel samples may be expanded or extended as discussed with respect to FIG. 5.

Training operation 602 is then performed to train multiple CNNLF candidates 613, one each for each of classifications 1 through M. As discussed, such CNNLF candidates 613 are each trained using regions that have the corresponding classification. It is noted that some pixel samples may be used from other regions in the case of expansion; however, the pixels that are central being processed (e.g., those shaded pixels in FIG. 5) are only from regions 611 having the pertinent classification. Each of CNNLF candidates 613 may have any characteristics as discussed herein with respect to CNNLFs 300, 400, 500. In an embodiment, each of CNNLF candidates 613 includes both a luma CNNLF and a chroma CNNLF, however, such pairs of CNNLFs may be described collectively as a CNNLF herein for the sake of clarity of presentation.

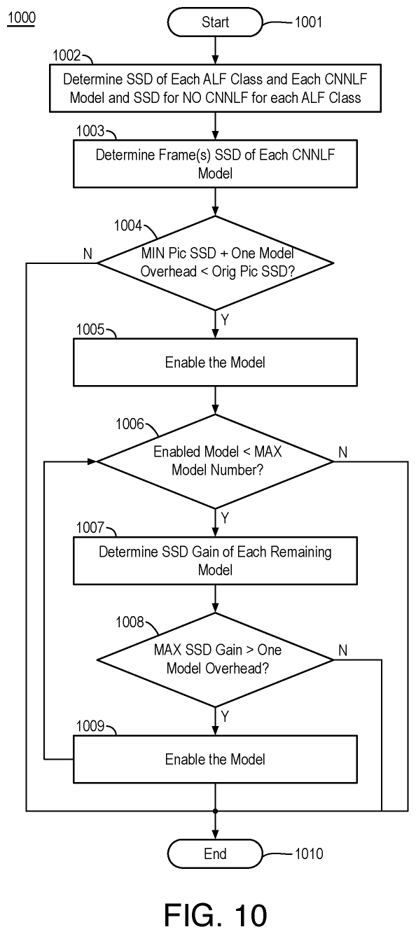

As shown, selection operation 603 is performed to select a subset 614 of CNNLF candidates 613 for use in encode. Selection operation 603 may be performed using any suitable technique or techniques such as those discussed herein with respect to FIG. 10. In some embodiments, selection operation 603 selects those of CNNLF candidates 613 that minimize distortion between original video frames 605 and filtered reconstructed video frames (i.e., reconstructed video frames 610 after application of the CNNLF). Such distortion measurements may be made using any suitable technique or techniques such as (MSE), sum of square differences (SDD), etc. Herein, discussion of distortion or of a specific distortion measurement may be replaced with any suitable distortion measurement. For example, distortion measurement or the like indicates MSE, SSD, or other suitable measurement while discussion of SSD specifically is also to indicate MSE, SSD, or other suitable measurement may be used. In an embodiment, subset 614 of CNNLF candidates 613 is selected using a maximum gain rule based on a greedy algorithm.

Subset 614 of CNNLF candidates 613 may include any number (X) of CNNLFs such as 1, 3, 5, 7, 15, or the like. In some embodiments, subset 614 may include up to X CNNLFs but only those that improve distortion by an amount that exceeds the model cost of the CNNLF are selected. Such techniques are discussed further herein with respect to FIG. 10.

Quantization operation 604 then quantizes each CNNLF of subset 614 for transmission to a decoder. Such quantization techniques may provide for reduction in the size of each CNNLF with minimal loss in performance and/or for meeting the requirement that any data encoded by entropy encoder 126 be in a quantized and fixed point representation.

FIG. 7 illustrates a flow diagram of an example process 700 for the classification of regions of one or more video frames using adaptive loop filter classification and pair sample extension for training convolutional neural network loop filters, arranged in accordance with at least some implementations of the present disclosure. As shown in FIG. 7, one or more reconstructed video frames 710, which correspond to original video frames 705, are selected for training and selecting CNNLFs. For example, original video frames 705 may be frames of video input 101 and reconstructed video frames 710 may be output from ALF 124.

Reconstructed video frames 710 may be selected using any suitable technique or techniques such as those discussed herein with respect to process 600 or FIG. 8. In some embodiments, temporal identification (ID) of a picture order count (POC) of video frames is used to select reconstructed video frames 710 such that temporal ID frames of 0 and 1 may be used for the training and selection while temporal ID frames of 2 are excluded from training.

Each of reconstructed video frames 710 are divided into regions 711. Reconstructed video frames 710 may be divided into any number of regions 711 of any size, such as 4×4 regions, for each region to be classified based on ALF classification. As shown with respect to ALF classification operation 701 each of regions 711 are then classified based on ALF classification into one of 25 classifications. For example, classifying each of regions 711 into their respective selected classifications may be based on an adaptive loop filter classification of each of regions 711 in accordance with a versatile video coding standard. Such classifications may be performed using any suitable technique or techniques in accordance with the VCC codec. In some embodiments, in region or block-based classification for an adaptive loop filtering in accordance with VCC, each 4×4 block derives a class by determining a metric using direction and activity information of the 4×4 block as is known in the art. As discussed, such classes may include 25 classes, however, any suitable number of classes in accordance with the VCC codec may be used. In some embodiments, the discussed division of reconstructed video frames 710 into regions 711 and the ALF classification of regions 711 may be copied from ALF 124 (which has already performed such operations) for complexity reduction and improved processing speed. For example, classifying each of regions 711 into a selected classification is based on an adaptive loop filter classification of each of regions 711 in accordance with a versatile video coding standard.

Based on ALF classification operation 701, paired pixel samples 712 for training are generated. As shown, for each classification, the corresponding regions 711 are used to pair pixel samples from original video frame 705 and reconstructed video frames 710. For example, for classification 1 (C=1), pixel samples from those regions classified into classification 1 are paired and used for training. Similarly, for classification 2 (C=2), pixel samples from those regions classified into classification 2 are paired and used for training, for classification 3 (C=3), pixel samples from those regions classified into classification 3 are paired and used for training, and so on. As used herein paired pixel samples are collocated pixels. As shown, paired pixel samples 712 are thereby classified data samples based on ALF classification operation 701. Furthermore, paired pixel samples 712 pair, in this example, 4×4 original pixel samples (i.e. from original video frame 705) and 4×4 reconstructed pixel samples (i.e., from reconstructed video frames 710) such that the 4×4 samples are in the luma domain.

Next, expansion operation 702 is used for view field extension or expansion of the reconstructed pixel samples from 4×4 pixel samples to, in this example, 12×12 pixel samples for improved CNN inference to generate paired pixel samples 713 for training of CNNLFs such as those modeled based on CNNLF 500. As shown, paired pixel samples 713 are also classified data samples based on ALF classification operation 701. Furthermore, paired pixel samples 713 pair, in the luma domain, 4×4 original pixel samples (i.e. from original video frame 705) and 12×12 reconstructed pixel samples (i.e., from reconstructed video frames 710). Thereby, training sets of paired pixel samples are provided with each set being for a particular classification/CNNLF combination. Each training set includes any number of pairs of 4×4 original pixel samples and 12×12 reconstructed pixel samples. For example, as shown in FIG. 7, regions of one or more video frames may be classified into 25 classifications with the block size of each classification for both original and reconstructed frame being 4×4, and the reconstructed blocks may then be extended to 12×12 to achieve more feature information in the training and inference of CNNLFs.

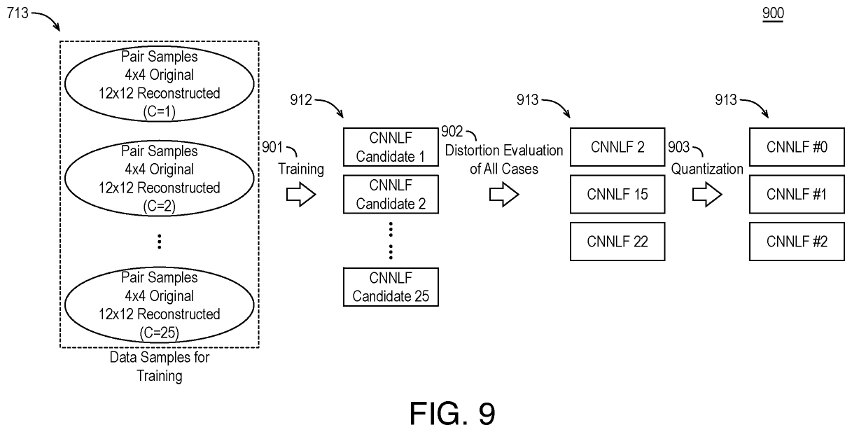

As discussed, each CNNLF is then trained using reconstructed pixel samples as input and original pixel samples as the ground truth for training of the CNNLF and a subset of the pretrained CNNLFs are selected for coding. Such training and selection are discussed with respect to FIG. 9 and elsewhere herein.

FIG. 8 illustrates an example group of pictures 800 for selection of video frames for convolutional neural network loop filter training, arranged in accordance with at least some implementations of the present disclosure. As shown in FIG. 8, group of pictures 800 includes frames 801-809 such that frames 801-809 have a POC of 0-8 respectively. Furthermore, arrows in FIG. 8 indicate potential motion compensation dependencies such that frame 801 has no reference frame (is an I frame) or has a single reference frame (not shown), frame 805 has only frame 801 as a reference frame, and frame 809 has only frame 805 as a reference frame. Due to only having no or a single reference frame, frames 801, 805, 809 are temporal ID 0. As shown, frame 803 has two reference frames 801, 805 that are temporal ID 0 and, similarly, frame 807 has two reference frames 805, 809 that are temporal ID 0. Due to only referencing temporal ID 0 reference frames, frames 803, 807 are temporal ID 1. Furthermore, frames 802, 804, 806, 808 reference both temporal ID 0 frames and temporal ID 1 frames. Due to referencing both temporal ID 0 and 1 frames, frames 802, 804, 806, 808 are temporal ID 2. Thereby, a hierarchy of frames 801-809 is provided.

In some embodiments, frames having a temporal structure as shown in FIG. 8 are selected for training CNNLFs based on their temporal IDs. In an embodiment, only frames of temporal ID 0 are used for training and frames of temporal ID 1 or 2 are excluded. In an embodiment, only frames of temporal ID 0 and 1 are used for training and frames of temporal ID 2 are excluded. In an embodiment, classifying, training, and selecting as discussed herein are performed on multiple reconstructed video frames inclusive of temporal identification 0 and exclusive of temporal identifications 1 and 2 such that the temporal identifications are in accordance with the versatile video coding standard. In an embodiment, classifying, training, and selecting as discussed herein are performed on multiple reconstructed video frames inclusive of temporal identification 0 and 1 and exclusive of temporal identification 2 such that the temporal identifications are in accordance with the versatile video coding standard.

FIG. 9 illustrates a flow diagram of an example process 900 for training multiple convolutional neural network loop filters using regions classified based on ALF classifications, selection of a subset of the multiple trained convolutional neural network loop filters, and quantization of the selected subset, arranged in accordance with at least some implementations of the present disclosure. As shown in FIG. 9, paired pixel samples 713 for training of CNNLFs, as discussed with respect to FIG. 7 may be received for processing. In some embodiments, the size of patch pair samples from the original frame is 4×4, which provide ground truth data or labels used in training, and the size of patch pair samples from the reconstructed frame is 12×12, which is the input channel data for training.

As discussed, 25 ALF classifications may be used to train 25 corresponding CNNLF candidates 912 via training operation 901. A CNNLF having any architecture discussed herein is trained with respect to each training sample set (e.g., C=1, C=2, . . . , C=25) of paired pixel samples 713 to generate a corresponding one of CNNLF candidates 912. As discussed, each of paired pixel samples 713 centers on only those pixel regions that correspond to the particular classification. Training operation 901 may be performed using any suitable CNN training operation using reconstructed pixel samples as the training set and corresponding original pixel samples as the ground truth information such as initiating CNN parameters, applying to one or more of the training sample, comparison to the ground truth information, and back propagation of the error, and so on until convergence is met or a particular number of training epochs have been performed.

After generation 25 CNNLF candidates 912, distortion evaluation 902 is performed to select a subset 913 of CNNLF candidates 912 such that subset 913 may include a maximum number (e.g., 1, 3, 5, 7, 15, etc.) of CNNLF candidates 912. Distortion evaluation 902 may include any suitable technique or techniques such as those discussed herein with respect to FIG. 10. In some embodiments, distortion evaluation 902 includes selection of N (N=3 in this example) of 25 CNNLF candidates 912 based on maximum gain rule by using a greedy algorithm. In an embodiment, a first one of CNNLF candidates 912 with a maximum accumulated gain is selected. Then a second one of CNNLF candidates 912 with a maximum accumulated gain after selection of the first one is selected, and then a third one with maximum accumulated gain after the first and second ones are. In the illustrated example, CNNLF candidates 912 2, 15, and 22 are selected for purposes of illustration.

Quantization operation 903 then quantizes each CNNLF of subset 913 for transmission to a decoder. Such quantization may be performed using any suitable technique or techniques. In an embodiment, each CNNLF model is quantized in accordance with Equation (1) as follows:

$${y}_{j} = \frac{{\sum }_{i} {w}_{j , i} {x}_{i} - {μ}_{j}}{{σ}_{j}} + {b}_{j} = \frac{1}{α β} ( {\sum }_{i} β {w}_{j , i}^{′} α {x}_{i}^{′} + αβ {b}_{j}^{′} ) \qquad ( 1 )$$

where yⱼ is the output of the j-th neuron in a current hidden layer before activation function (i.e. ReLU function), w_{j,i} is the weight between the i-th neuron of the former layer and the j-th neuron in the current layer, and bⱼ is the bias in the current layer. Considering a batch normalization (BN) layer, μⱼ is the moving average and σⱼ is the moving variance. If no BN layer is implemented, then μⱼ=0 and σⱼ=1. The right portion of Equation (1) is another form of the expression that is based on the BN layer being merged with the convolutional layer. In Equation (1), α and β are scaling factors for quantization that are affected by bit width.

In some embodiments, the range of fix-point data x′ is from −31 to 31 for 6-bit weights and x is the floating point data such that α may be provided as shown in Equation (2):

$$α = \frac{max ( {x}^{′} )}{max ( x )} \qquad ( 2 )$$

Furthermore, in some embodiments, β may be determined based on a fix-point weight precision w_{target} and floating point weight range such that β may be provided as shown in Equation (3):

$$β = \frac{{w}_{target}}{max ( \vert {w}_{j , i}^{′} \vert )} \qquad ( 3 )$$

Based on the above, the quantization Equations (4) are as follows:

$${w}_{j , i}^{′} = \frac{{w}_{j , i}}{{σ}_{j}} \qquad ( 4 )$$

$${w}_{i n t} = {w}_{j , i}^{′} * \frac{{w}_{j , i}}{max ( {w}_{j , i}^{′} )} * β$$

$${b}_{j}^{′} = ( {b}_{j} - \frac{{μ}_{j}}{{σ}_{j}} )$$

$${b}_{i n t} = {b}_{j}^{′} * α * β$$

where primes indicate quantized versions of the CNNLF parameters. Such quantized CNNLF parameters may be entropy encoded by entropy encoder 126 for inclusion in bitstream 102.

FIG. 10 is a flow diagram illustrating an example process 1000 for selecting a subset of convolutional neural network loop filters from convolutional neural network loop filters candidates, arranged in accordance with at least some implementations of the present disclosure. Process 1000 may include one or more operations 1001-1010 as illustrated in FIG. 10. Process 1000 may be performed by any device discussed herein. In some embodiments, process 1000 is performed at selection operation 603 and/or distortion evaluation 902.

Processing begins at start operation 1001, where each trained candidate CNNLF (e.g., CNNLF candidates 613 or CNNLF candidates 912) is used to process each training reconstructed video frame. The training reconstructed video frames may include the same frames used to train the CNNLFs for example. Notably, such processing provides a number of frames equal to the number of candidate CNNLFs times the number of training frames (which may be one or more). Furthermore, the reconstructed video frames themselves are used as a baseline for evaluation of the CNNLFs (such reconstructed video frames and corresponding distortion measurements are also referred to as original since no CNNLF processing has been performed. Also, the original video frames corresponding to the reconstructed video frames are used to determine the distortion of the CNNLF processed reconstructed video frames (e.g., filtered reconstructed video frames) as discussed further herein. The processing performed at operation 1001 generates the frames needed to evaluate the candidate CNNLFs. Furthermore, at start operation 1001, the number of enabled CNNLF models, N, is set to zero (N=0) to indicate no CNNLFs are yet selected. Thereby, at operation 1001, each of multiple trained convolutional neural network loop filters are applied to reconstructed video frames used for training of the CNNLFs.

Processing continues at operation 1002, where, for each class, i, and each CNNLF model, j, a distortion value, SSD[i][j] is determined. That is, for each region of the reconstructed video frames having a particular classification and for each CNNLF model as applied to those regions, a distortion value. For example, the regions for every combination of each classification and each CNNLF model from the filtered reconstructed video frames (e.g., after processing by the particular CNNLF model) may be compared to the corresponding regions of the original video frames and a distortion value is generated. As discussed, the distortion value may correspond to any measure of pixel wise distortion such as SSD, MSE, etc. In the following discussion, SSD is used for the sake of clarity of presentation but MSE or any other measure may be substituted as is known in the art.

Furthermore, at operation 1002, a baseline distortion value (or original distortion value) is generated for each class, i, as SSD[i][0]. The baseline distortion value represents the distortion, for the regions of the particular class, between the regions of the reconstructed video frames the regions of the original video frames. That is, the baseline distortion is the distortion present without use of any CNNLF application. Such baseline distortion is useful as a CNNLF may only be applied to a particular region when the CNNLF improves distortion. If not, as discussed further herein, the region/classification may simply be mapped to skip CNNLF via a mapping table. Thereby, at operation 1002, a distortion value is determined for each combination of classifications (e.g., ALF classifications) as provided by SSD[i][j] (e.g., having i×j such SSD values) and the trained convolutional neural network loop filters and, for each of the classifications, a baseline distortion value without use of any trained convolutional neural network loop filter as provided by SSD[i][0] (e.g., having i such SSD values).

Processing continues at operation 1003, where frame level distortion values are determined for the reconstructed video frames for each of the candidate CNNLFs, k. The term frame level distortion value is used to indicate the distortion is not at the region level. Such a frame level distortion may be determined for a single frame (e.g., when one reconstructed video frame is used for training and selection) or for multiple frames (e.g., when multiple reconstructed video frames are used for training and selection). Notably, when a particular candidate CNNLF, k, is evaluated for reconstructed video frame(s), either the candidate CNNLF itself may be applied to each region class or no CNNLF may be applied to each region. Therefore, per class application of CNNLF v. no CNNLF (with the option having lower distortion being used) is used to determine per class distortion for the reconstructed video frame(s) and the sum of per class distortions is generated for each candidate CNNLF. In some embodiments, a frame level distortion value for a particular candidate CNNLF, k, is generated as shown in Equation (5):

$$picSSD [ k ] = {\sum }_{ALF class i} min ( S S D [ i ] [ 0 ] , SS D [ i ] [ k ] ) \qquad ( 5 )$$

where picSSD[k] is the frame level distortion and is determined by summing, across all classes (e.g., ALF classes), the minimum of, for each class, the distortion value CNNLF application (SSD[i][k]) and the baseline distortion value for the class SSD[i][0]. Thereby, for the reconstructed video frame(s), a frame level distortion is generated for each of the trained convolutional neural network loop filters based on the distortion values for the particular trained convolutional neural network loop filter and the baseline distortion values. Such per candidate CNNLF frame level distortion values are subsequently used for selection from the candidate CNNLFs.

Processing continues at decision operation 1004, where a determination is made as to whether a minimum of the frame level distortion values summed with one model overhead is less than a baseline distortion value for the reconstructed video frame(s). As used herein, the term model overhead indicates the amount of bandwidth (e.g., in units translated for evaluation in distortion space) needed to transmit a CNNLF. The model overhead may be an actual overhead corresponding to a particular CNNLF or a representative overhead (e.g., an average CNNLF overhead estimated CNNLF overhead, etc.). Furthermore, the baseline distortion value for the reconstructed video frame(s), as discussed, is the distortion of the reconstructed video frame(s) with respect to the corresponding original video frame(s) such that the baseline distortion is measured without application of any CNNLF. Notably, if no CNNLF application reduces distortion by the overhead corresponding thereto, no CNNLF is transmitted (e.g., for the GOP being processed) as shown with respect to processing ending at end operation 1010 if no such candidate CNNLF is found.

If, however, the candidate CNNLF corresponding to the minimum frame level distortion satisfies the requirement that the minimum of the frame level distortion values summed with one model overhead is less than the baseline distortion value for the reconstructed video frame(s), then processing continues at operation 1005, where the candidate CNNLF corresponding to the minimum frame level distortion is enabled (e.g., is selected for use in encode and transmission to a decoder). That is, at operations 1003, 1004, and 1005, the frame level distortion of all candidate CNNLF models and the minimum thereof (e.g., minimum picture SSD) is determined. For example, the CNNLF model corresponding thereto may be indicated as CNNLF model a with a corresponding frame level distortion of picSSD[a]. If picSSD[a]+1 model overhead<picSSD[0], go to operation 1005 (where CNNLF a is set as the first enabled model and the number of enabled CNNLF models, N, is set to 1, N=1), otherwise go to operation 1010, where picSSD[0] is the baseline frame level distortion. Thereby, a trained convolutional neural network loop filter is selected for use in encode and transmission to a decoder such that the selected trained convolutional neural network loop filter has the lowest frame level distortion.

Processing continues at decision operation 1006, where a determination is made as to whether the current number of enabled or selected CNNLFs has met a maximum CNNLF threshold value (MAX_MODEL_NUM). The maximum CNNLF threshold value may be any suitable number (e.g., 1, 3, 5, 7, 15, etc.) and may be preset for example. As shown, if the maximum CNNLF threshold value has been met, process 1000 ends at end operation 1010. If not, processing continues at operation 1007. For example, if N<MAX_MODEL_NUM, go to operation 1007, otherwise go to operation 1010.

Processing continues at operation 1007, where, for each of the remaining CNNLF models (excluding a and any other CNNLF models selected at preceding operations), a distortion gain is generated and a maximum of the distortion gains (MAX SSD) is compared to one model overhead (as discussed with respect to operation 1004). Processing continues at decision operation 1008, where, if the maximum of the distortion gains exceeds one model overhead, then processing continues at operation 1009, where the candidate CNNLF corresponding to the maximum distortion gain is enabled (e.g., is selected for use in encode and transmission to a decoder). If not, processing ends at end operation 1010 since no remaining CNNLF model reduces distortion more than the cost of transmitting the model. Each distortion gain may be generated using any suitable technique or techniques such as in accordance with Equation (6):

$$SSDGain [ k ] = {\sum }_{ALF class i} max ( min ( S S D [ i ] [ 0 ] , SS D [ i ] [ a ] ) - S S D [ i ] [ k ] , 0 ) \qquad ( 6 )$$

where SSDGain[k] is the frame level distortion gain (e.g., using all reconstructed reference frame(s) as discussed) for CNNLF k and a refers to all previously enabled models (e.g., one or more models). Notably CNNLF a (as previously enabled) is not evaluated (k≠a). That is, at operations 1007, 1008, and 1009, the frame level gain of all remaining candidate CNNLF models and the maximum thereof (e.g., maximum SSD gain) is determined. For example, the CNNLF model corresponding thereto may be indicated as CNNLF model b with a corresponding frame level gain of SSDGain[b]. If SSDGain[b]>1 model overhead, go to operation 1009 (where CNNLF b is set as another enabled model and the number of enabled CNNLF models, N, is incremented, N+=1), otherwise go to operation 1010. Thereby, a second trained convolutional neural network loop filter is selected for inclusion in the subset in response to the second trained convolutional neural network loop filter having a frame level distortion gain using the second trained convolutional neural network loop filter over use of only the first trained convolutional neural network loop filter (CNNLF a) that exceeds a model overhead.

If a model is enabled or selected at operation 1009, processing continues at operation 1006 as discussed above until either a maximum number of CNNLF models have been enabled (at decision operation 1006) or selected or a maximum frame level distortion gain among remaining CNNLF models does not exceed one model overhead (at decision operation 1008).

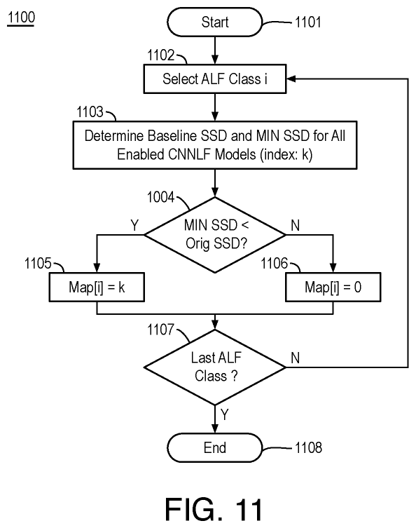

FIG. 11 is a flow diagram illustrating an example process 1100 for generating a mapping table that maps classifications to selected convolutional neural network loop filter or skip filtering, arranged in accordance with at least some implementations of the present disclosure. Process 1100 may include one or more operations 1101-1108 as illustrated in FIG. 11. Process 1100 may be performed by any device discussed herein.

Notably, since a subset of CNNLFs are selected, a mapping must be provided between each of the classes (e.g., M classes) and a particular one of the CNNLFs of the subset or to skip CNNLF processing for the class. During encode such processing selects a CNNLF for each class (e.g., ALF class) or skip CNNLF. Such processing is performed for all reconstructed video frames encoded using the current subset of CNNLFs (and not just reconstructed video frames used for training). For example, for each video frame in a GOP using the subset of CNNLFs selected as discussed above, a mapping table may be generated and the mapping table may be encoded in a frame header for example.

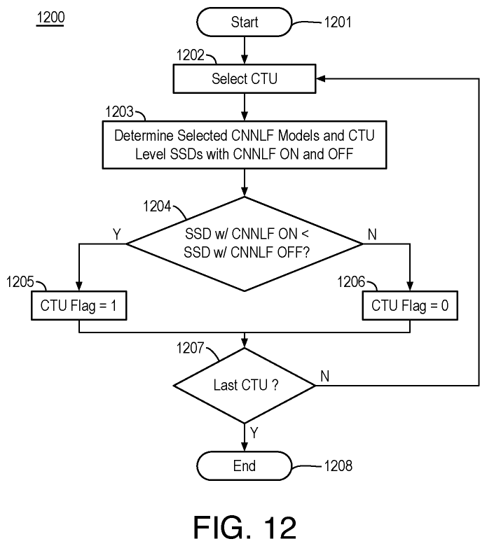

A decoder then receives the mapping table and CNNLFs, performs division into regions and classification on reconstructed video frames in the same manner as the encoder, optionally de-quantizes the CNNLFs and then applies CNNLFs (or skips) in accordance with the mapping table and coding unit flags as discussed with respect to FIG. 12 below. Notably, a decoder device separate from an encoder device may perform any pertinent operations discussed herein with respect to encoding and such operations may be generally described as coding operations.

Processing begins at start operation 1101, where mapping table generation is initiated. As discussed, such a mapping table maps each class of multiple classes (e.g., 1 to M classes) to one of a subset of CNNLFs (e.g., 1 to X enabled or selected CNNLFs) or to a skip CNNLF (e.g., 0 or null). That is, process 1100 generates a mapping table to map classifications to a subset of trained convolutional neural network loop filters for any reconstructed video frame being encoded by a video coder. The mapping table may then be decoded for use in decoding operations.

Processing continues at operation 1102, where a particular class (e.g., an ALF class) is selected. For example, at a first iteration, class 1 is selected, at a second iteration, class 2 is selected and so on. Processing continues at operation 1103, where, for the selected class of the reconstructed video frame being encoded, a baseline or original distortion is determined. In some embodiments, the baseline distortion is a pixel wise distortion measure (e.g., SSD, MSE, etc.) between regions having class i of the reconstructed video frame (e.g., a frame being processed by CNNLF processing) and corresponding regions of an original video frame (corresponding to the reconstructed video frame). As discussed, baseline distortion is the distortion of a reconstructed video frame or regions thereof (e.g., after ALF processing) without use of CNNLF.

Furthermore, at operation 1103, for the selected class of the reconstructed video frame being encoded, a minimum distortion corresponding to a particular one of the enabled CNNLF models (e.g., model k) is determined. For example, regions of the reconstructed video frame having class i may be processed with each of the available CNNLFs and the resultant regions (e.g., CNN filtered reconstructed regions) having class i are compared to corresponding regions of the original video frame. Alternatively, the reconstructed video frame may be processed with each available CNNLF and the resultant frames may be compared, on a class by class basis with the original video frame. In any event, for class i, the minimum distortion (MIN SSD) corresponding to a particular CNNLF (index k) is determined. For example, at operations 1102 (as all iterations are performed), for each ALF class i, a baseline or original SSD (oriSSD[i]) and the minimum SSD (minSSD[i]) of all enabled CNNLF modes (index k) are determined.

Processing continues at decision operation 1104, where a determination is made as to whether the minimum distortion is less than the baseline distortion. If so, processing continues at operation 1105, where the current class (class i) is mapped to the CNNLF model having the minimum distortion (CNNLF k) to generate a mapping table entry (e.g., map[i]=k). If not, processing continues at operation 1106, where the current class (class i) is mapped to a skip CNNLF index to generate a mapping table entry (e.g., map[i]=0). That is, if minSSD[i]<oriSSD[i], then map[i]=k, else map[i]=0.

Processing continues from either of operations 1105, 1106 at decision operation 1107, where a determination is made as to whether the class selected at operation 1102 is the last class to be processed. If so, processing continues at end operation 1108, where the completed mapping table contains, for each class, a corresponding one of an available CNNLF or a skip CNNLF processing entry. If not, processing continues at operations 1102-1107 until each class has been processed. Thereby, a mapping table to map classifications to a subset of the trained convolutional neural network loop filters for a reconstructed video frame is generated by a mapping table to map classifications to the subset of the trained convolutional neural network loop filters for a second reconstructed video frame by classifying each region of multiple regions of a reconstructed video frame into a selected classification of multiple classifications (e.g., process 1100 pre-processing performed as discussed with respect to processes 600, 700), determining, for each of the classifications, a minimum distortion (minSSD[i]) with use of a selected one of a subset of convolutional neural network loop filters (CNNLF k) and a baseline distortion (oriSSD[i]) without use of any trained convolutional neural network loop filter, and assigning, for each of the classifications, the selected one of the subset of the trained convolutional neural network loop filters in response to the minimum distortion being less than the baseline distortion for the classification (if minSSD[i]<oriSSD[i], then map[i]=k) or skip convolutional neural network loop filtering in response to the minimum distortion not being less than the baseline distortion for the classification (else map[i]=0).

FIG. 12 is a flow diagram illustrating an example process 1200 for determining coding unit level flags for use of convolutional neural network loop filtering or to skip convolutional neural network loop filtering, arranged in accordance with at least some implementations of the present disclosure. Process 1200 may include one or more operations 1201-1208 as illustrated in FIG. 12. Process 1200 may be performed by any device discussed herein.

Notably, during encode and decode, the CNNLF processing discussed herein may be enabled or disabled at a coding unit or coding tree unit level or the like. For example, in HEVC and VCC, a coding tree unit is a basic processing unit and corresponds to a macroblock of units in AVC and previous standards. Herein, the term coding unit indicates a coding tree unit (e.g., of HEVC or VCC), a macroblock (e.g., of AVC), or any level of block partitioned for high level decisions in a video codec. As discussed, reconstructed video frames may be divided into regions and classified. Such regions do not correspond to coding unit partitioning. For example, ALF regions may be 4×4 regions or blocks and coding tree units may be 64×64 pixel samples. Therefore, in some contexts, CNNLF processing may be advantageously applied to some coding units and not others, which may be flagged as discussed with respect to process 1200.

A decoder then receives the coding unit flags and performs CNNLF processing only for those coding units (e.g., CTUs) for which CNNLF processing is enabled (e.g., flagged as ON or 1). As discussed with respect to FIG. 11, a decoder device separate from an encoder device may perform any pertinent operations discussed herein with respect to encoding such as, in the context of FIG. 12, decoding coding unit CNNLF flags and only applying CNNLFs to those coding units (e.g., CTUs) for which CNNLF processing is enabled.

Processing begins at start operation 1201, where coding unit CNNLF processing flagging operations are initiated. Processing continues at operation 1202, where a particular coding unit is selected. For example, coding tree units of a reconstructed video frame may be selected in a raster scan order.

Processing continues at operation 1203, where, for the selected coding unit (ctuIdx), for each classified region therein (e.g., regions 611 regions 711, etc.) such as 4×4 regions (blkIdx), the corresponding classification is determined (c[blkIdx]). For example, the classification may be the ALF class for the 4×4 region as discussed herein. Then the CNNLF for each region is determined using the mapping table discussed with respect to process 1100 (map[c[blkIdx]]). For example, the mapping table is referenced based on the class of each 4×4 region to determine the CNNLF for each region (or no CNNLF) of the coding unit.

The respective CNNLFs and skips are then applied to the coding unit and the distortion of the filtered coding unit is determined with respect to the corresponding coding unit of the original video frame. That is, the coding unit after proposed CNNLF processing in accordance with the classification of regions thereof and the mapping table (e.g., a filtered reconstructed coding unit) is compared to the corresponding original coding unit to generate a coding unit level distortion. For example, the distortions of each of the regions (blkSSD[map[c[blkIdx]]] of the coding unit may be summed to generate a coding unit level distortion with CNNLF on (ctuSSDOn+=blkSSD[map[c[blkIdx]]]). Furthermore, a coding unit level distortion with CNNLF off (ctuSSDOff) is also generated based on a comparison of the incoming coding unit (e.g., a reconstructed coding unit without application of CNNLF processing).

Processing continues at decision operation 1204, where a determination is made as to whether the distortion with CNNLF processing on (ctuSSDOn) is less than the baseline distortion (e.g., distortion with CNNLF processing off, ctuSSDOff). If so, processing continues at operation 1205, where a CNNLF processing flag for the current coding unit is set to ON (CTU Flag=1). If not processing continues at operation 1206, where a CNNLF processing flag for the current coding unit is set to OFF (CTU Flag=0). That is, if ctuSSDOn<ctuSSDOff, then ctuFlag=1, else ctuFlag=0.

Processing continues from either of operations 1205, 1206 at decision operation 1207, where a determination is made as to whether the coding unit selected at operation 1202 is the last coding unit to be processed. If so, processing continues at end operation 1208, where the completed CNNLF coding flags for the current reconstructed video frame are encoded into a bitstream. If not, processing continues at operations 1202-1207 until each coding unit has been processed. Thereby, coding unit CNNLF flags are generated by determining, for a coding unit of a reconstructed video frame, a coding unit level distortion with convolutional neural network loop filtering on (ctuSSOn) using a mapping table (map) indicating which of the subset of the trained convolutional neural network loop filters are to be applied to blocks of the coding unit and flagging convolutional neural network loop filtering on in response to the coding unit level distortion being less than a coding unit level distortion without use of convolutional neural network loop filtering (if ctuSSDOn<ctuSSDOff, then ctuFlag=1) or off in response to the coding unit level distortion not being less than a coding unit level distortion without use of convolutional neural network loop filtering (else ctuFlag=0).

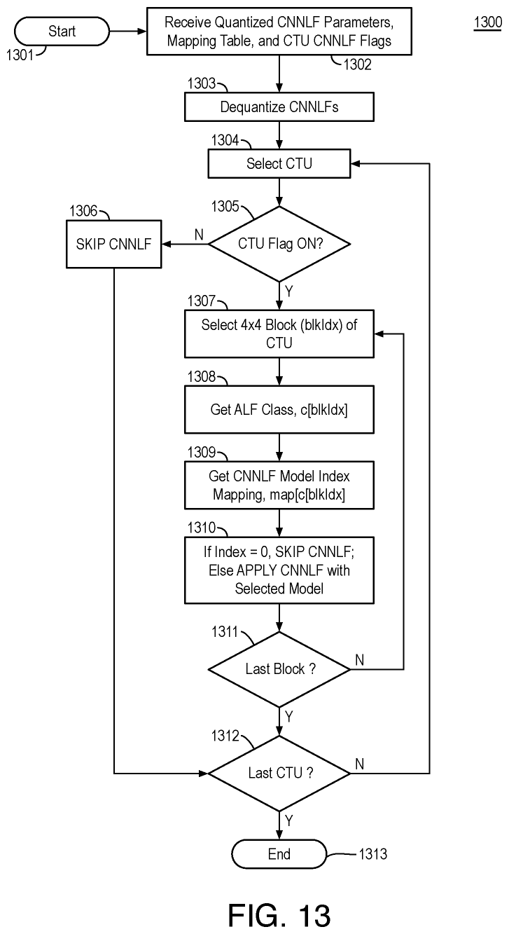

FIG. 13 is a flow diagram illustrating an example process 1300 for performing decoding using convolutional neural network loop filtering, arranged in accordance with at least some implementations of the present disclosure. Process 1300 may include one or more operations 1301-1313 as illustrated in FIG. 13. Process 1300 may be performed by any device discussed herein.

Processing begins at start operation 1301, where at least a part of decoding of a video fame may be initiated. For example, a reconstructed video frame (e.g., after ALF processing) may be received for CNNLF processing for improved subjective and objective quality. Processing continues at operation 1302, where quantized CNNLF parameters, a mapping table and coding unit CNNLF flags are received. For example, the quantized CNNLF parameters may be representative of one or more CNNLFs for decoding a GOP of which the reconstructed video frame is a member. Although discussed with respect to quantized CNNLF parameters, in some embodiments, the CNNLF parameters are not quantized and operation 1303 may be skipped. Furthermore, the mapping table and coding unit CNNLF flags are pertinent to the current reconstructed video frame. For example, a separate mapping table may be provided for each reconstructed video frame. In some embodiments, the reconstructed video frame is received from ALF decode processing for CNNLF decode processing.

Processing continues at operation 1303, where the quantized CNNLF parameters are de-quantized. Such de-quantization may be performed using any suitable technique or techniques such as inverse operations to those discussed with respect to Equations (1) through (4). Processing continues at operation 1304, where a particular coding unit is selected. For example, coding tree units of a reconstructed video frame may be selected in a raster scan order.

Processing continues at decision operation 1305, where a determination is made as to whether a CNNLF flag for the coding unit selected at operation 1304 indicates CNNLF processing is to be performed. If not (ctuFlag=0), processing continues at operation at operation 1306, where CNNLF processing is skipped for the current coding unit.

If so (ctuFlag=1), processing continues at operation 1307, where a region or block of the coding unit is selected such that the region or block (blkIdx) is a region for CNNLF processing (e.g., region 611, region 711, etc.) as discussed herein. In some embodiments, the region or block is an ALF region. Processing continues at operation 1308, where the classification (e.g., ALF class) is determined for the current region of the current coding unit (c[blkIdx]). The classification may be determined using any suitable technique or techniques. In an embodiment, the classification is performed during ALF processing in the same manner as that performed by the encoder (in a local decode loop as discussed) such that decoder processing replicates that performed at the encoder. Notably, since ALF classification or other classification that is replicable at the decoder is employed, the signaling overhead for implementation (or not) of a particular selected CNNLF is drastically reduced.

Processing continues at operation 1309, where the CNNLF for the selected region or block is determined based on the mapping table received at operation 1302. As discussed, the mapping table maps classes (c) to a particular one of the CNNLFs received at operation 1302 (or no CNNLF if processing is skipped for the region or block). Thereby, the CNNLF for the current region or block of the current coding unit, a particular CNNLF is determined (map[c[blkIdx]]=1, 2, or 3, etc.) or skip CNNLF is determined (map[c[blkIdx]]=0).

Processing continues at operation 1310, where the current region or block is CNNLF processed. As shown, in response skip CNNLF is indicated (e.g., Index=map[c[blkIdx]]=0), CNNLF processing is skipped for the region or block. Furthermore, in response to a particular CNNLF being indicated for the region or block, the indicated particular CNNLF (selected model) is applied to the block using any CNNLF techniques discussed herein such as inference operations discussed with respect to FIG. 3-5. The resultant filtered pixel samples (e.g., filtered reconstructed video frame pixel samples) are stored as output from CNNLF processing and may be used in loop (e.g., for motion compensation and presentation to a user via a display) or out of loop (e.g., only for presentation to a user via a display).

Processing continues at operation 1311, where a determination is made as to whether the region or block selected at operation 1307 is the last region or block of the current coding unit to be processed. If not, processing continues at operations 1307-1311 until each region or block of the current coding unit has been processed. If so, processing continues at decision operation 1312 (or processing continues from operation 1306 to decision operation 1312), where a determination is made as to whether the coding unit selected at operation 1304 is the last coding unit to be processed. If so, processing continues at end operation 1313, where the completed CNNLF filtered reconstructed video frame is stored to a frame buffer, used for prediction of subsequent video frames, presented to a user, etc. If not, processing continues at operations 1304-1312 until each coding unit has been processed.

Discussion now turns to CNNLF syntax, which is illustrated with respect to Tables A, B, C, and D. Table A provides an exemplary sequence parameter set RBSP (raw byte sequence payload) syntax, Table B provides an exemplary slice header syntax, Table C provides an exemplary coding tree unit syntax, and Tables D provide exemplary CNNLF syntax for the implementation of the techniques discussed herein. In the following, acnnlf_luma_params_present_flag equal to 1 specifies that acnnlf_luma_coeff( ) syntax structure will be present and acnnlf_luma_params_present_flag equal to 0 specifies that the acnnlf_luma_coeff( ) syntax structure will not be present. Furthermore, acnnlf_chroma_params_present_flag equal to 1 specifies that acnnlf_chroma_coeff( ) syntax structure will be present and acnnlf_chroma_params_present_flag equal to 0 specifies that the acnnlf_chroma_coeff( ) syntax structure will not be present.

Although presented with the below syntax for the sake of clarity, any suitable syntax may be used.

TABLE A
Sequence Parameter Set RBSP Syntax

| | Descriptor |
|---|---|
| seq_parameter_set_rbsp( ) { | |
| sps_seq_parameter_set_id | ue(v) |
| chroma_format_idc | ue(v) |
| if( chroma_format_idc = = 3 ) | |
| separate_colour_plane_flag | u(1) |
| pic_width_in_luma_samples | ue(v) |
| pic_height_in_luma_samples | ue(v) |
| bit_depth_luma_minus8 | ue(v) |
| bit_depth_chroma_minus8 | ue(v) |
| log2_ctu_size_minus2 | ue(v) |
| log2_min_qt_size_intra_slices_minus2 | ue(v) |
| log2_min_qt_size_inter_slices_minus2 | ue(v) |
| max_mtt_hierarchy_depth_inter_slices | ue(v) |
| max_mtt_hierarchy_depth_intra_slices | ue(v) |
| sps_acnnlf_enable_flag | u(1) |
| if ( sps_acnnlf_enable_flag ){ | |
| log2_acnnblock_width | ue(v) |
| } | |
| rbsp_trailing_bits( ) | |
| } | |

TABLE B
Slice Header Syntax

| | Descriptor |
|---|---|
| slice_header( ) { | |
| slice_pic_parameter_set_id | ue(v) |
| slice_address | u(v) |
| slice_type | ue(v) |
| if ( sps_acnnlf_enable_flag ){ | |
| if ( slice_type == I ) { | |
| acnnlf_luma_params_present_flag | u(1) |
| if(acnnlf_luma_params_present_flag){ | |
| acnnlf_luma_coeff ( ) | |
| acnnlf_and_alf_classification_mapping_table ( ) | |
| } | |
| acnnlf_chroma_params_present_flag | u(1) |
| if(acnnlf_chroma_params_present_flag){ | |
| acnnlf_chroma_coeff ( ) | |
| } | |
| } | |
| acnnlf_luma _slice _enable_flag | u(1) |
| acnnlf_chroma _slice _enable_flag | u(1) |
| } | |
| byte_alignment( ) | |
| } | |

TABLE C
Coding Tree Unit Syntax

| | Descriptor |
|---|---|
| coding_tree_unit( ) { | |
| xCtb = ( CtbAddrInRs % PicWidthInCtbsY ) << | |
| CtbLog2SizeY | |
| yCtb = ( CtbAddrInRs / PicWidthInCtbsY ) << | |
| CtbLog2SizeY | |
| if(acnnlf_luma _slice _enable_flag ){ | |
| acnnlf_luma _ctb_flag | u(1) |
| } | |
| if(acnnlf_chroma _slice _enable_flag ){ | |
| acnnlf_chroma_ctb_flag | u(1) |
| } | |
| coding_quadtree( xCtb, yCtb, CtbLog2SizeY, 0 ) | |
| } | |

TABLES D
CNNLF Syntax

| | Descriptor |
|---|---|
| acnnlf_luma_coeff ( ) { | |
| num_luma_cnnlf | u(3) |
| num_luma_cnnlf_l1size | tu(v) |
| num_luma_cnnlf_l1_output_channel | tu(v) |
| num_luma_cnnlf_l2size | tu(v) |
| L1_Input = 6, L1Size = num_luma_cnnlf_l1size, M = | |
| num_luma_cnnlf_l1_output_channel, L2Size = num_ | |
| luma_cnnlf_l2size, K = 4 | |
| for( cnnIdx = 0; cnnIdx < num_luma_cnnlf; cnnIdx ++ ) | |
| two_layers_cnnlf_coeff(L1_Input, L1Size, M, L2Size, K) | |
| } | |
| acnnlf_chroma_coeff ( ) { | |
| num_chroma_cnnlf | u(3) |
| num_chroma_cnnlf_l1size | tu(v) |
| num_chroma_cnnlf_l1_output_channel | tu(v) |
| num_chroma_cnnlf_l2size | tu(v) |
| L1_Input = 6, L1Size = num_chroma_cnnlf_l1size, M = | |
| num_chroma_cnnlf_l1_output_channel, L2Size = num_ | |
| chroma_cnnlf_l2size, K = 2 | |
| for( cnnIdx = 0; cnnIdx < num_chroma_cnnlf; cnnIdx ++ ) | |
| two_layers_cnnlf_coeff(L1_Input, L1Size, M, L2Size, K) | |
| } | |
| two_layers_cnnlf_coeff(L1_Input, L1Size, M, L2Size, K) { | |
| for(l1Idx = 0; l1Idx < M; l1Idx++ ) { | |
| l1_cnn_bias [l1Idx] | tu(v) |
| } | |
| for(l1Idx = 0; llIdx < M; l1Idx ++ ) | |
| for( inChIdx = 0; inChIdx < L1_Input; inChIdx ++ ) | |
| for( yIdx = 0; yIdx < L1Size; yIdx ++ ) | |
| for( xIdx = 0; xIdx < L1Size; xIdx ++ ) | |
| cnn_weight[l1Idx][ inChIdx] [ yIdx][ xIdx] | tu(v) |
| } | |
| for( l2Idx = 0; l2Idx < K; l2Idx++ ) | |
| L2_cnn_bias [l2Idx] | tu(v) |
| for(l2Idx = 0; l2Idx < K; l2Idx ++ ) | |
| for( inChIdx = 0; inChIdx < M; inChIdx ++ ) | |
| for( yIdx = 0; yIdx < L2Size; yIdx ++ ) | |
| for( xIdx = 0; xIdx < L2Size; xIdx ++ ) | |
| cnn_weight[l2Idx] [ inChIdx] [ yIdx][ xIdx] | tu(v) |
| } | |
| acnnlf_and_alf_classification_mapping_table ( ) { | |
| for( alfIdx = 0; alfIdx < num_alf_classification; alfIdx ++ ) | |
| acnnlf_idc [alfIdx] | u(2) |
| } | |

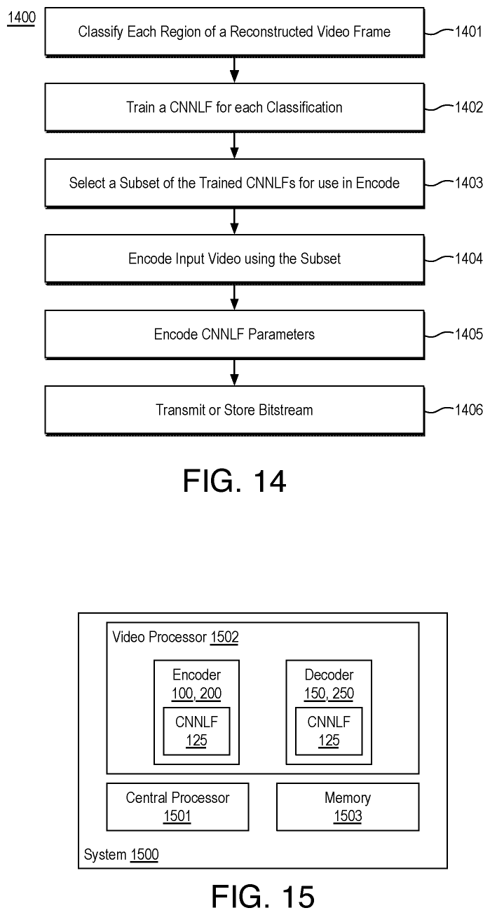

FIG. 14 is a flow diagram illustrating an example process 1400 for video coding including convolutional neural network loop filtering, arranged in accordance with at least some implementations of the present disclosure. Process 1400 may include one or more operations 1401-1406 as illustrated in FIG. 14. Process 1400 may form at least part of a video coding process. By way of non-limiting example, process 1400 may form at least part of a video coding process as performed by any device or system as discussed herein. Furthermore, process 1400 will be described herein with reference to system 1500 of FIG. 15.

FIG. 15 is an illustrative diagram of an example system 1500 for video coding including convolutional neural network loop filtering, arranged in accordance with at least some implementations of the present disclosure. As shown in FIG. 15, system 1500 may include a central processor 1501, a video processor 1502, and a memory 1503. Also as shown, video processor 1502 may include or implement any one or more of encoders 100, 200 (thereby including CNNLF 125 in loop or out of loop on the encode side) and/or decoders 150, 250 (thereby including CNNLF 125 in loop or out of loop on the decode side). Furthermore, in the example of system 1500, memory 1503 may store video data or related content such as frame data, reconstructed frame data, CNNLF data, mapping table data, and/or any other data as discussed herein.

As shown, in some embodiments, any of encoders 100, 200 and/or decoders 150, 250 are implemented via video processor 1502. In other embodiments, one or more or portions of encoders 100, 200 and/or decoders 150, 250 are implemented via central processor 1501 or another processing unit such as an image processor, a graphics processor, or the like.

Video processor 1502 may include any number and type of video, image, or graphics processing units that may provide the operations as discussed herein. Such operations may be implemented via software or hardware or a combination thereof. For example, video processor 1502 may include circuitry dedicated to manipulate pictures, picture data, or the like obtained from memory 1503. Central processor 1501 may include any number and type of processing units or modules that may provide control and other high level functions for system 1500 and/or provide any operations as discussed herein. Memory 1503 may be any type of memory such as volatile memory (e.g., Static Random Access Memory (SRAM), Dynamic Random Access Memory (DRAM), etc.) or non-volatile memory (e.g., flash memory, etc.), and so forth. In a non-limiting example, memory 1503 may be implemented by cache memory.

In an embodiment, one or more or portions of encoders 100, 200 and/or decoders 150, 250 are implemented via an execution unit (EU). The EU may include, for example, programmable logic or circuitry such as a logic core or cores that may provide a wide array of programmable logic functions. In an embodiment, one or more or portions of encoders 100, 200 and/or decoders 150, 250 are implemented via dedicated hardware such as fixed function circuitry or the like. Fixed function circuitry may include dedicated logic or circuitry and may provide a set of fixed function entry points that may map to the dedicated logic for a fixed purpose or function.

Returning to discussion of FIG. 14, process 1400 begins at operation 1401, where each of multiple regions of at least one reconstructed video frame are classified into a selected classification of a plurality of classifications such that the reconstructed video frame corresponding to an original video frame of input video. In some embodiments, the at least one reconstructed video frame includes one or more training frames. Notably, however, such classification selection may be used for training CNNLFs and for use in video coding. In some embodiments, the classifying discussed with respect to operation 1401, training discussed with respect to operation 1402, and selecting discussed with respect to operation 1403 are performed on a plurality of reconstructed video frames inclusive of temporal identification 0 and 1 frames and exclusive of temporal identification 2 frames such that the temporal identifications are in accordance with a versatile video coding standard. Such classification may be performed based on any characteristics of the regions. In an embodiment, classifying each of the regions into the selected classifications is based on an adaptive loop filter classification of each of the regions in accordance with a versatile video coding standard.

Processing continues at operation 1402, where a convolutional neural network loop filter is trained for each of the classifications using those regions having the corresponding selected classification to generate multiple trained convolutional neural network loop filters. For example, a convolutional neural network loop filter is trained for each of the classifications (or at least all classifications for which a region was classified). The convolutional neural network loop filters may have the same architectures or they may be different. Furthermore, the convolutional neural network loop filters may have any characteristics discussed herein. In some embodiments, each of the convolutional neural network loop filters has an input layer and only two convolutional layers, a first convolutional layer having a rectified linear unit after each convolutional filter thereof and second convolutional layer having a direct skip connection with the input layer.

Processing continues at operation 1403, where a subset of the trained convolutional neural network loop filters are selected such that the subset includes at least a first trained convolutional neural network loop filter that minimizes distortion between the original video frame and a filtered video frame generated using the reconstructed video frame and the first trained convolutional neural network loop filter. In some embodiments,

In some embodiments, selecting the subset of the trained convolutional neural network loop filters includes applying each of the trained convolutional neural network loop filters to the reconstructed video frame, determining a distortion value for each combination of the classifications and the trained convolutional neural network loop filters and, for each of the classifications, a baseline distortion value without use of any trained convolutional neural network loop filter, generating, for the reconstructed video frame, a frame level distortion for each of the trained convolutional neural network loop filters based on the distortion values for the particular trained convolutional neural network loop filter and the baseline distortion values, and selecting the first trained convolutional neural network loop filter as the trained convolutional neural network loop filter having the lowest frame level distortion. In some embodiments, process 1400 further includes selecting a second trained convolutional neural network loop filter for inclusion in the subset in response to the second trained convolutional neural network loop filter having a frame level distortion gain using the second trained convolutional neural network loop filter over use of only the first trained convolutional neural network loop filter that exceeds a model overhead of the second trained convolutional neural network loop filter.

In some embodiments, process 1400 further includes generating a mapping table to map classifications to the subset of the trained convolutional neural network loop filters for a second reconstructed video frame by classifying each of a plurality of second regions of the second reconstructed video frame into a second selected classification of the classifications, determining, for each of the classifications, a minimum distortion with use of a selected one of the subset of the trained convolutional neural network loop filters and a baseline distortion without use of any trained convolutional neural network loop filter, and assigning, for each of the classifications, the selected one of the subset of the trained convolutional neural network loop filters in response to the minimum distortion being less than the baseline distortion for the classification or skip convolutional neural network loop filtering in response to the minimum distortion not being less than the baseline distortion for the classification. For example, the mapping table maps the (many) classifications to one of the (few) convolutional neural network loop filters or a null (for no application of convolutional neural network loop filter).

In some embodiments, process 1400 further includes determining, for a coding unit of a second reconstructed video frame, a coding unit level distortion with convolutional neural network loop filtering on using a mapping table indicating which of the subset of the trained convolutional neural network loop filters are to be applied to blocks of the coding unit and flagging convolutional neural network loop filtering on in response to the coding unit level distortion being less than a coding unit level distortion without use of convolutional neural network loop filtering or off in response to the coding unit level distortion not being less than a coding unit level distortion without use of convolutional neural network loop filtering. For example, coding unit flags may be generated for application of the corresponding convolutional neural network loop filters as indicated by the mapping table for regions of the coding unit (coding unit flag ON) or for no application of convolutional neural network loop filters (coding unit flag OFF).

Processing continues at operation 1404, where the input video is encoded based at least in part on the subset of the trained convolutional neural network loop filters. For example, all video frames (e.g., reconstructed video frames) within a GOP may be encoded using the convolutional neural network loop filters trained and selected using a training set of video frames (e.g., reconstructed video frames) of the GOP. In some embodiments, encoding the input video based at least in part on the subset of the trained convolutional neural network loop filters includes receiving a luma region, a first chroma channel region, and a second chroma channel region, determining expanded regions around and including each of the luma region, the first chroma channel region, and the second chroma channel region, generating an input for the trained convolutional neural network loop filters comprising multiple channels including a first, second, third, and fourth channels corresponding to sub-samplings of pixel samples of the expanded luma region, a fifth channel corresponding to pixel samples of the expanded first chroma channel region, and a sixth channel corresponding to pixel samples of the expanded second chroma channel region, and generating an input for the trained convolutional neural network loop filters comprising multiple channels including a first, second, third, and fourth channels corresponding to sub-samplings of pixel samples of the expanded luma region, a fifth channel corresponding to pixel samples of the expanded first chroma channel region, and a sixth channel corresponding to pixel samples of the expanded second chroma channel region.

Processing continues at operation 1405, where encoding convolutional neural network loop filter parameters for each convolutional neural network loop filter of the subset and the encoded video into a bitstream. The convolutional neural network loop filter parameters may be encoded using any suitable technique or techniques. In some embodiments, encoding the convolutional neural network loop filter parameters for each convolutional neural network loop filter of the subset comprises quantizing parameters of each convolutional neural network loop filter. Furthermore the encoded video may be encoded into the bitstream using any suitable technique or techniques.

Processing continues at operation 1406, where the bitstream is transmitted and/or stored. The bitstream may be transmitted and/or stored using any suitable technique or techniques. In an embodiment, the bitstream is stored in a local memory such as memory 1503. In an embodiment, the bitstream is transmitted for storage at a hosting device such as a server. In an embodiment, the bitstream is transmitted by system 1500 or a server for use by a decoder device.

Process 1500 may be repeated any number of times either in series or in parallel for any number sets of pictures, video segments, or the like. As discussed, process 1500 may provide for video encoding including convolutional neural network loop filtering.

Furthermore, process 1500 may include operations performed by a decoder (e.g., as implemented by system 1500). Such operations may include any operations performed by the encoder that are pertinent to decode as discussed herein. For example, the bitstream transmitted at operation 1406 may be received. A reconstructed video frame may be generated using decode operations. Each region of the reconstructed video frame may be classified as discussed with respect to operation 1401 and the mapping table and coding unit flags discussed above may be decoded. Furthermore, the subset of trained CNNLFs may be formed by decoding the corresponding CNNLF parameters and performing de-quantization as needed.

Then, for each coding unit of the reconstructed video, the corresponding coding unit flag is evaluated. If the flag indicates no CNNLF application, CNNLF is skipped. If, however the indicates CNNLF application, processing continues with each region of the coding unit being processed. In some embodiments, for each region, the classification discussed above is referenced (or performed if not done already) and, using the mapping table, the CNNLF for the region is determined (or no CNNLF may be determined from the mapping table). The pretrained CNNLF corresponding to the classification of the region is then applied to the region to generate filtered reconstructed pixel samples. Such processing is performed for each region of the coding unit to generate a filtered reconstructed coding unit. The coding units are then merged to provide a CNNLF filtered reconstructed reference frame, which may be used as a reference for the reconstruction of other frames and for presentation to a user (e.g., the CNNLF may be applied in loop) or for presentation to a user only (e.g., the CNNLF may be applied out of loop). For example, system 1500 may perform any operations discussed with respect to FIG. 13.

Various components of the systems described herein may be implemented in software, firmware, and/or hardware and/or any combination thereof. For example, various components of the systems or devices discussed herein may be provided, at least in part, by hardware of a computing System-on-a-Chip (SoC) such as may be found in a computing system such as, for example, a smart phone. Those skilled in the art may recognize that systems described herein may include additional components that have not been depicted in the corresponding figures. For example, the systems discussed herein may include additional components such as bit stream multiplexer or de-multiplexer modules and the like that have not been depicted in the interest of clarity.

While implementation of the example processes discussed herein may include the undertaking of all operations shown in the order illustrated, the present disclosure is not limited in this regard and, in various examples, implementation of the example processes herein may include only a subset of the operations shown, operations performed in a different order than illustrated, or additional operations.

In addition, any one or more of the operations discussed herein may be undertaken in response to instructions provided by one or more computer program products. Such program products may include signal bearing media providing instructions that, when executed by, for example, a processor, may provide the functionality described herein. The computer program products may be provided in any form of one or more machine-readable media. Thus, for example, a processor including one or more graphics processing unit(s) or processor core(s) may undertake one or more of the blocks of the example processes herein in response to program code and/or instructions or instruction sets conveyed to the processor by one or more machine-readable media. In general, a machine-readable medium may convey software in the form of program code and/or instructions or instruction sets that may cause any of the devices and/or systems described herein to implement at least portions of the operations discussed herein and/or any portions the devices, systems, or any module or component as discussed herein.

As used in any implementation described herein, the term “module” refers to any combination of software logic, firmware logic, hardware logic, and/or circuitry configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, fixed function circuitry, execution unit circuitry, and/or firmware that stores instructions executed by programmable circuitry. The modules may, collectively or individually, be embodied as circuitry that forms part of a larger system, for example, an integrated circuit (IC), system on-chip (SoC), and so forth.

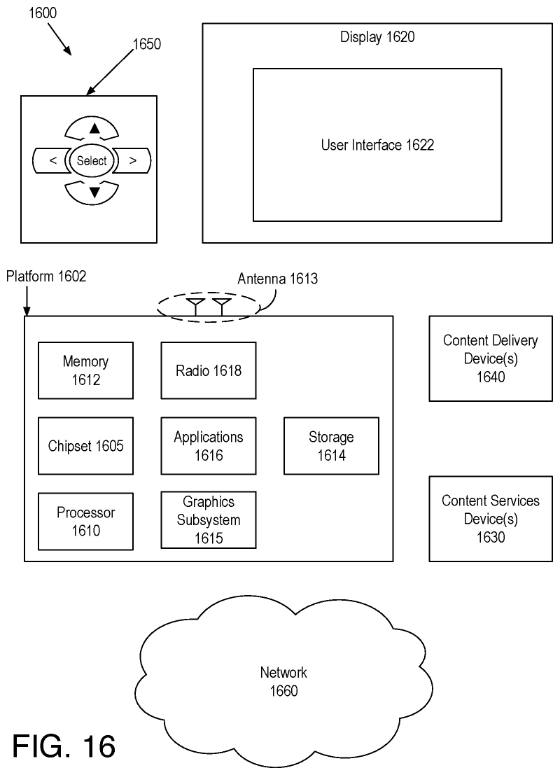

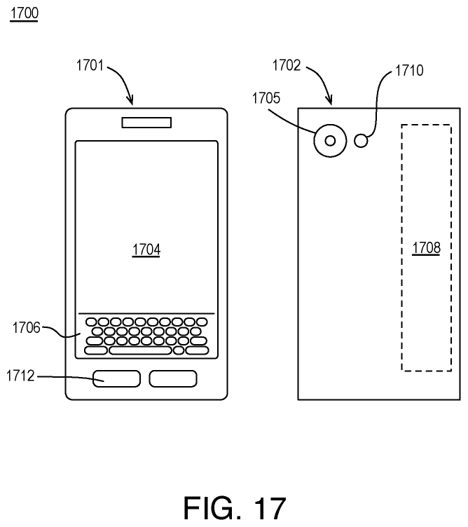

FIG. 16 is an illustrative diagram of an example system 1600, arranged in accordance with at least some implementations of the present disclosure. In various implementations, system 1600 may be a mobile system although system 1600 is not limited to this context. For example, system 1600 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, cameras (e.g. point-and-shoot cameras, super-zoom cameras, digital single-lens reflex (DSLR) cameras), and so forth.

In various implementations, system 1600 includes a platform 1602 coupled to a display 1620. Platform 1602 may receive content from a content device such as content services device(s) 1630 or content delivery device(s) 1640 or other similar content sources. A navigation controller 1650 including one or more navigation features may be used to interact with, for example, platform 1602 and/or display 1620. Each of these components is described in greater detail below.

In various implementations, platform 1602 may include any combination of a chipset 1605, processor 1610, memory 1612, antenna 1613, storage 1614, graphics subsystem 1615, applications 1616 and/or radio 1618. Chipset 1605 may provide intercommunication among processor 1610, memory 1612, storage 1614, graphics subsystem 1615, applications 1616 and/or radio 1618. For example, chipset 1605 may include a storage adapter (not depicted) capable of providing intercommunication with storage 1614.

Processor 1610 may be implemented as a Complex Instruction Set Computer (CISC) or Reduced Instruction Set Computer (RISC) processors, x86 instruction set compatible processors, multi-core, or any other microprocessor or central processing unit (CPU). In various implementations, processor 1610 may be dual-core processor(s), dual-core mobile processor(s), and so forth.

Memory 1612 may be implemented as a volatile memory device such as, but not limited to, a Random Access Memory (RAM), Dynamic Random Access Memory (DRAM), or Static RAM (SRAM).

Storage 1614 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 1614 may include technology to increase the storage performance enhanced protection for valuable digital media when multiple hard drives are included, for example.

Graphics subsystem 1615 may perform processing of images such as still or video for display. Graphics subsystem 1615 may be a graphics processing unit (GPU) or a visual processing unit (VPU), for example. An analog or digital interface may be used to communicatively couple graphics subsystem 1615 and display 1620. For example, the interface may be any of a High-Definition Multimedia Interface, DisplayPort, wireless HDMI, and/or wireless HD compliant techniques. Graphics subsystem 1615 may be integrated into processor 1610 or chipset 1605. In some implementations, graphics subsystem 1615 may be a stand-alone device communicatively coupled to chipset 1605.

The graphics and/or video processing techniques described herein may be implemented in various hardware architectures. For example, graphics and/or video functionality may be integrated within a chipset. Alternatively, a discrete graphics and/or video processor may be used. As still another implementation, the graphics and/or video functions may be provided by a general purpose processor, including a multi-core processor. In further embodiments, the functions may be implemented in a consumer electronics device.

Radio 1618 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 1618 may operate in accordance with one or more applicable standards in any version.

In various implementations, display 1620 may include any television type monitor or display. Display 1620 may include, for example, a computer display screen, touch screen display, video monitor, television-like device, and/or a television. Display 1620 may be digital and/or analog. In various implementations, display 1620 may be a holographic display. Also, display 1620 may be a transparent surface that may receive a visual projection. Such projections may convey various forms of information, images, and/or objects. For example, such projections may be a visual overlay for a mobile augmented reality (MAR) application. Under the control of one or more software applications 1616, platform 1602 may display user interface 1622 on display 1620.

In various implementations, content services device(s) 1630 may be hosted by any national, international and/or independent service and thus accessible to platform 1602 via the Internet, for example. Content services device(s) 1630 may be coupled to platform 1602 and/or to display 1620. Platform 1602 and/or content services device(s) 1630 may be coupled to a network 1660 to communicate (e.g., send and/or receive) media information to and from network 1660. Content delivery device(s) 1640 also may be coupled to platform 1602 and/or to display 1620.

In various implementations, content services device(s) 1630 may include a cable television box, personal computer, network, telephone, Internet enabled devices or appliance capable of delivering digital information and/or content, and any other similar device capable of uni-directionally or bi-directionally communicating content between content providers and platform 1602 and/display 1620, via network 1660 or directly. It will be appreciated that the content may be communicated uni-directionally and/or bi-directionally to and from any one of the components in system 1600 and a content provider via network 1660. Examples of content may include any media information including, for example, video, music, medical and gaming information, and so forth.

Content services device(s) 1630 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 1602 may receive control signals from navigation controller 1650 having one or more navigation features. The navigation features of may be used to interact with user interface 1622, for example. In various embodiments, navigation may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of may be replicated on a display (e.g., display 1620) by movements of a pointer, cursor, focus ring, or other visual indicators displayed on the display. For example, under the control of software applications 1616, the navigation features located on navigation may be mapped to virtual navigation features displayed on user interface 1622, for example. In various embodiments, may not be a separate component but may be integrated into platform 1602 and/or display 1620. The present disclosure, however, is not limited to the elements or in the context shown or described herein.

In various implementations, drivers (not shown) may include technology to enable users to instantly turn on and off platform 1602 like a television with the touch of a button after initial boot-up, when enabled, for example. Program logic may allow platform 1602 to stream content to media adaptors or other content services device(s) 1630 or content delivery device(s) 1640 even when the platform is turned “off” In addition, chipset 1605 may include hardware and/or software support for 5.1 surround sound audio and/or high definition 7.1 surround sound audio, for example. Drivers may include a graphics driver for integrated graphics platforms. In various embodiments, the graphics driver may include a peripheral component interconnect (PCI) Express graphics card.

In various implementations, any one or more of the components shown in system 1600 may be integrated. For example, platform 1602 and content services device(s) 1630 may be integrated, or platform 1602 and content delivery device(s) 1640 may be integrated, or platform 1602, content services device(s) 1630, and content delivery device(s) 1640 may be integrated, for example. In various embodiments, platform 1602 and display 1620 may be an integrated unit. Display 1620 and content service device(s) 1630 may be integrated, or display 1620 and content delivery device(s) 1640 may be integrated, for example. These examples are not meant to limit the present disclosure.

In various embodiments, system 1600 may be implemented as a wireless system, a wired system, or a combination of both. When implemented as a wireless system, system 1600 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 1600 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 1602 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 16.

As described above, system 1600 may be embodied in varying physical styles or form factors. FIG. 17 illustrates an example small form factor device 1700, arranged in accordance with at least some implementations of the present disclosure. In some examples, system 1600 may be implemented via device 1700. In other examples, system 100 or portions thereof may be implemented via device 1700. In various embodiments, for example, device 1700 may be implemented as a mobile computing device a having wireless capabilities. A mobile computing device may refer to any device having a processing system and a mobile power source or supply, such as one or more batteries, for example.

Examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, smart device (e.g., smart phone, smart tablet or smart mobile television), mobile internet device (MID), messaging device, data communication device, cameras, and so forth.

Examples of a mobile computing device also may include computers that are arranged to be worn by a person, such as a wrist computers, finger computers, ring computers, eyeglass computers, belt-clip computers, arm-band computers, shoe computers, clothing computers, and other wearable computers. In various embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 17, device 1700 may include a housing with a front 1701 and a back 1702. Device 1700 includes a display 1704, an input/output (I/O) device 1706, and an integrated antenna 1708. Device 1700 also may include navigation features 1712. I/O device 1706 may include any suitable I/O device for entering information into a mobile computing device. Examples for I/O device 1706 may include an alphanumeric keyboard, a numeric keypad, a touch pad, input keys, buttons, switches, microphones, speakers, voice recognition device and software, and so forth. Information also may be entered into device 1700 by way of microphone (not shown), or may be digitized by a voice recognition device. As shown, device 1700 may include a camera 1705 (e.g., including a lens, an aperture, and an imaging sensor) and a flash 1710 integrated into back 1702 (or elsewhere) of device 1700. In other examples, camera 1705 and flash 1710 may be integrated into front 1701 of device 1700 or both front and back cameras may be provided. Camera 1705 and flash 1710 may be components of a camera module to originate image data processed into streaming video that is output to display 1704 and/or communicated remotely from device 1700 via antenna 1708 for example.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as IP cores may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

In one or more first embodiments, a method for video coding comprises classifying each of a plurality of regions of at least one reconstructed video frame into a selected classification of a plurality of classifications, the reconstructed video frame corresponding to an original video frame of input video, training a convolutional neural network loop filter for each of the classifications using those regions having the corresponding selected classification to generate a plurality of trained convolutional neural network loop filters, selecting a subset of the trained convolutional neural network loop filters, the subset comprising at least a first trained convolutional neural network loop filter that minimizes distortion between the original video frame and a filtered video frame generated using the reconstructed video frame and the first trained convolutional neural network loop filter, encoding the input video based at least in part on the subset of the trained convolutional neural network loop filters, and encoding convolutional neural network loop filter parameters for each convolutional neural network loop filter of the subset and the encoded video into a bitstream.

In one or more second embodiments, further to the first embodiments, classifying each of the regions into the selected classifications is based on an adaptive loop filter classification of each of the regions in accordance with a versatile video coding standard.

In one or more third embodiments, further to the first or second embodiments, selecting the subset of the trained convolutional neural network loop filters comprises applying each of the trained convolutional neural network loop filters to the reconstructed video frame, determining a distortion value for each combination of the classifications and the trained convolutional neural network loop filters and, for each of the classifications, a baseline distortion value without use of any trained convolutional neural network loop filter, generating, for the reconstructed video frame, a frame level distortion for each of the trained convolutional neural network loop filters based on the distortion values for the particular trained convolutional neural network loop filter and the baseline distortion values, and selecting the first trained convolutional neural network loop filter as the trained convolutional neural network loop filter having the lowest frame level distortion.

In one or more fourth embodiments, further to the first through third embodiments, the method further comprises selecting a second trained convolutional neural network loop filter for inclusion in the subset in response to the second trained convolutional neural network loop filter having a frame level distortion gain using the second trained convolutional neural network loop filter over use of only the first trained convolutional neural network loop filter that exceeds a model overhead of the second trained convolutional neural network loop filter.

In one or more fifth embodiments, further to the first through fourth embodiments, the method further comprises generating a mapping table to map classifications to the subset of the trained convolutional neural network loop filters for a second reconstructed video frame by classifying each of a plurality of second regions of the second reconstructed video frame into a second selected classification of the classifications, determining, for each of the classifications, a minimum distortion with use of a selected one of the subset of the trained convolutional neural network loop filters and a baseline distortion without use of any trained convolutional neural network loop filter, and assigning, for each of the classifications, the selected one of the subset of the trained convolutional neural network loop filters in response to the minimum distortion being less than the baseline distortion for the classification or skip convolutional neural network loop filtering in response to the minimum distortion not being less than the baseline distortion for the classification.

In one or more sixth embodiments, further to the first through fifth embodiments, the method further comprises determining, for a coding unit of a second reconstructed video frame, a coding unit level distortion with convolutional neural network loop filtering on using a mapping table indicating which of the subset of the trained convolutional neural network loop filters are to be applied to blocks of the coding unit and flagging convolutional neural network loop filtering on in response to the coding unit level distortion being less than a coding unit level distortion without use of convolutional neural network loop filtering or off in response to the coding unit level distortion not being less than a coding unit level distortion without use of convolutional neural network loop filtering.

In one or more seventh embodiments, further to the first through sixth embodiments, encoding the convolutional neural network loop filter parameters for each convolutional neural network loop filter of the subset comprises quantizing parameters of each convolutional neural network loop filter.

In one or more eighth embodiments, further to the first through seventh embodiments, encoding the input video based at least in part on the subset of the trained convolutional neural network loop filters comprises receiving a luma region, a first chroma channel region, and a second chroma channel region, determining expanded regions around and including each of the luma region, the first chroma channel region, and the second chroma channel region, generating an input for the trained convolutional neural network loop filters comprising multiple channels including a first, second, third, and fourth channels corresponding to sub-samplings of pixel samples of the expanded luma region, a fifth channel corresponding to pixel samples of the expanded first chroma channel region, and a sixth channel corresponding to pixel samples of the expanded second chroma channel region, and applying the first trained convolutional neural network loop filter to the multiple channels.

In one or more ninth embodiments, further to the first through eighth embodiments, each of the convolutional neural network loop filters comprises an input layer and only two convolutional layers, a first convolutional layer having a rectified linear unit after each convolutional filter thereof and second convolutional layer having a direct skip connection with the input layer.

In one or more tenth embodiments, further to the first through ninth embodiments, said classifying, training, and selecting are performed on a plurality of reconstructed video frames inclusive of temporal identification 0 and 1 frames and exclusive of temporal identification 2 frames, wherein the temporal identifications are in accordance with a versatile video coding standard.

In one or more eleventh embodiments, a device or system includes a memory and a processor to perform a method according to any one of the above embodiments.

In one or more twelfth embodiments, at least one machine readable medium includes a plurality of instructions that in response to being executed on a computing device, cause the computing device to perform a method according to any one of the above embodiments.

In one or more thirteenth embodiments, an apparatus may include means for performing a method according to any one of the above embodiments.

It will be recognized that the embodiments are not limited to the embodiments so described, but can be practiced with modification and alteration without departing from the scope of the appended claims. For example, the above embodiments may include specific combination of features. However, the above embodiments are not limited in this regard and, in various implementations, the above embodiments may include the undertaking only a subset of such features, undertaking a different order of such features, undertaking a different combination of such features, and/or undertaking additional features than those features explicitly listed. The scope of the embodiments should, therefore, be determined with reference to the appended claims, along with the full scope of equivalents to which such claims are entitled.

1-24. (canceled)

25. An apparatus, comprising:
a memory to store at least one reconstructed video frame; and
one or more processors coupled to the memory, the one or more processors to:
classify each of a plurality of regions of the at least one reconstructed video frame into a selected classification of a plurality of classifications, the reconstructed video frame corresponding to an original video frame of input video;
train a convolutional neural network loop filter for each of the classifications using those regions having the corresponding selected classification to generate a plurality of trained convolutional neural network loop filters;
select a subset of the trained convolutional neural network loop filters, the subset comprising at least a first trained convolutional neural network loop filter that minimizes distortion between the original video frame and a filtered video frame generated using the reconstructed video frame and the first trained convolutional neural network loop filter;
encode the input video based at least in part on the subset of the trained convolutional neural network loop filters; and
encode convolutional neural network loop filter parameters for each convolutional neural network loop filter of the subset and the encoded video into a bitstream.

26. The apparatus of claim 25, wherein the one or more processors to classify each of the regions into the selected classifications is based on an adaptive loop filter classification of each of the regions in accordance with a versatile video coding standard.

27. The apparatus of claim 25, wherein the one or more processors to select the subset of the trained convolutional neural network loop filters comprises the one or more processors to:
apply each of the trained convolutional neural network loop filters to the reconstructed video frame;
determine a distortion value for each combination of the classifications and the trained convolutional neural network loop filters and, for each of the classifications, a baseline distortion value without use of any trained convolutional neural network loop filter;
generate, for the reconstructed video frame, a frame level distortion for each of the trained convolutional neural network loop filters based on the distortion values for the particular trained convolutional neural network loop filter and the baseline distortion values; and
select the first trained convolutional neural network loop filter as the trained convolutional neural network loop filter having the lowest frame level distortion.

28. The apparatus of claim 27, the one or more processors to:
select a second trained convolutional neural network loop filter for inclusion in the subset in response to the second trained convolutional neural network loop filter having a frame level distortion gain using the second trained convolutional neural network loop filter over use of only the first trained convolutional neural network loop filter that exceeds a model overhead of the second trained convolutional neural network loop filter.

29. The apparatus of claim 25, the one or more processors to:
generate a mapping table to map classifications to the subset of the trained convolutional neural network loop filters for a second reconstructed video frame by the one or more processors to:
classify each of a plurality of second regions of the second reconstructed video frame into a second selected classification of the classifications;
determine, for each of the classifications, a minimum distortion with use of a selected one of the subset of the trained convolutional neural network loop filters and a baseline distortion without use of any trained convolutional neural network loop filter; and
assign, for each of the classifications, the selected one of the subset of the trained convolutional neural network loop filters in response to the minimum distortion being less than the baseline distortion for the classification or skip convolutional neural network loop filtering in response to the minimum distortion not being less than the baseline distortion for the classification.

30. The apparatus of claim 25, the one or more processors to:
determine, for a coding unit of a second reconstructed video frame, a coding unit level distortion with convolutional neural network loop filtering on using a mapping table indicating which of the subset of the trained convolutional neural network loop filters are to be applied to blocks of the coding unit; and
flag convolutional neural network loop filtering on in response to the coding unit level distortion being less than a coding unit level distortion without use of convolutional neural network loop filtering or off in response to the coding unit level distortion not being less than a coding unit level distortion without use of convolutional neural network loop filtering.

31. The apparatus of claim 25, wherein the one or more processors to encode the convolutional neural network loop filter parameters for each convolutional neural network loop filter of the subset comprises the one or more processors to quantize parameters of each convolutional neural network loop filter.

32. The apparatus of claim 25, wherein the one or more processors to encode the input video based at least in part on the subset of the trained convolutional neural network loop filters comprises the one or more processors to:
receive a luma region, a first chroma channel region, and a second chroma channel region;
determine expanded regions around and including each of the luma region, the first chroma channel region, and the second chroma channel region;
generate an input for the trained convolutional neural network loop filters comprising multiple channels including a first, second, third, and fourth channels corresponding to sub-samplings of pixel samples of the expanded luma region, a fifth channel corresponding to pixel samples of the expanded first chroma channel region, and a sixth channel corresponding to pixel samples of the expanded second chroma channel region; and
apply the first trained convolutional neural network loop filter to the multiple channels.

33. The apparatus of claim 25, wherein each of the convolutional neural network loop filters comprises an input layer and only two convolutional layers, a first convolutional layer having a rectified linear unit after each convolutional filter thereof and second convolutional layer having a direct skip connection with the input layer.

34. The apparatus of claim 25, wherein the one or more processors classify, train, and select are performed on a plurality of reconstructed video frames inclusive of temporal identification 0 and 1 frames and exclusive of temporal identification 2 frames, wherein the temporal identifications are in accordance with a versatile video coding standard.

35. A method for video coding comprising:
classifying each of a plurality of regions of at least one reconstructed video frame into a selected classification of a plurality of classifications, the reconstructed video frame corresponding to an original video frame of input video;
training a convolutional neural network loop filter for each of the classifications using those regions having the corresponding selected classification to generate a plurality of trained convolutional neural network loop filters;
selecting a subset of the trained convolutional neural network loop filters, the subset comprising at least a first trained convolutional neural network loop filter that minimizes distortion between the original video frame and a filtered video frame generated using the reconstructed video frame and the first trained convolutional neural network loop filter;
encoding the input video based at least in part on the subset of the trained convolutional neural network loop filters; and
encoding convolutional neural network loop filter parameters for each convolutional neural network loop filter of the subset and the encoded video into a bitstream.

36. The method of claim 35, wherein classifying each of the regions into the selected classifications is based on an adaptive loop filter classification of each of the regions in accordance with a versatile video coding standard.

37. The method of claim 35, wherein selecting the subset of the trained convolutional neural network loop filters comprises:
applying each of the trained convolutional neural network loop filters to the reconstructed video frame;
determining a distortion value for each combination of the classifications and the trained convolutional neural network loop filters and, for each of the classifications, a baseline distortion value without use of any trained convolutional neural network loop filter;
generating, for the reconstructed video frame, a frame level distortion for each of the trained convolutional neural network loop filters based on the distortion values for the particular trained convolutional neural network loop filter and the baseline distortion values; and
selecting the first trained convolutional neural network loop filter as the trained convolutional neural network loop filter having the lowest frame level distortion.

38. The method of claim 35, further comprising:
generating a mapping table to map classifications to the subset of the trained convolutional neural network loop filters for a second reconstructed video frame by:
classifying each of a plurality of second regions of the second reconstructed video frame into a second selected classification of the classifications;
determining, for each of the classifications, a minimum distortion with use of a selected one of the subset of the trained convolutional neural network loop filters and a baseline distortion without use of any trained convolutional neural network loop filter; and
assigning, for each of the classifications, the selected one of the subset of the trained convolutional neural network loop filters in response to the minimum distortion being less than the baseline distortion for the classification or skip convolutional neural network loop filtering in response to the minimum distortion not being less than the baseline distortion for the classification.

39. The method of claim 35, further comprising:
determining, for a coding unit of a second reconstructed video frame, a coding unit level distortion with convolutional neural network loop filtering on using a mapping table indicating which of the subset of the trained convolutional neural network loop filters are to be applied to blocks of the coding unit; and
flagging convolutional neural network loop filtering on in response to the coding unit level distortion being less than a coding unit level distortion without use of convolutional neural network loop filtering or off in response to the coding unit level distortion not being less than a coding unit level distortion without use of convolutional neural network loop filtering.

40. The method of claim 35, wherein encoding the input video based at least in part on the subset of the trained convolutional neural network loop filters comprises:
receiving a luma region, a first chroma channel region, and a second chroma channel region;
determining expanded regions around and including each of the luma region, the first chroma channel region, and the second chroma channel region;
generating an input for the trained convolutional neural network loop filters comprising multiple channels including a first, second, third, and fourth channels corresponding to sub-samplings of pixel samples of the expanded luma region, a fifth channel corresponding to pixel samples of the expanded first chroma channel region, and a sixth channel corresponding to pixel samples of the expanded second chroma channel region;
applying the first trained convolutional neural network loop filter to the multiple channels.

41. At least one machine readable medium comprising a plurality of instructions that, in response to being executed on a computing device, cause the computing device to perform video coding by:
classifying each of a plurality of regions of at least one reconstructed video frame into a selected classification of a plurality of classifications, the reconstructed video frame corresponding to an original video frame of input video;
training a convolutional neural network loop filter for each of the classifications using those regions having the corresponding selected classification to generate a plurality of trained convolutional neural network loop filters;
selecting a subset of the trained convolutional neural network loop filters, the subset comprising at least a first trained convolutional neural network loop filter that minimizes distortion between the original video frame and a filtered video frame generated using the reconstructed video frame and the first trained convolutional neural network loop filter;
encoding the input video based at least in part on the subset of the trained convolutional neural network loop filters; and
encoding convolutional neural network loop filter parameters for each convolutional neural network loop filter of the subset and the encoded video into a bitstream.

42. The machine readable medium of claim 41, wherein classifying each of the regions into the selected classifications is based on an adaptive loop filter classification of each of the regions in accordance with a versatile video coding standard.

43. The machine readable medium of claim 41, wherein selecting the subset of the trained convolutional neural network loop filters comprises:
applying each of the trained convolutional neural network loop filters to the reconstructed video frame;
determining a distortion value for each combination of the classifications and the trained convolutional neural network loop filters and, for each of the classifications, a baseline distortion value without use of any trained convolutional neural network loop filter;
generating, for the reconstructed video frame, a frame level distortion for each of the trained convolutional neural network loop filters based on the distortion values for the particular trained convolutional neural network loop filter and the baseline distortion values; and
selecting the first trained convolutional neural network loop filter as the trained convolutional neural network loop filter having the lowest frame level distortion.

44. The machine readable medium of claim 41, further comprising:
generating a mapping table to map classifications to the subset of the trained convolutional neural network loop filters for a second reconstructed video frame by:
classifying each of a plurality of second regions of the second reconstructed video frame into a second selected classification of the classifications;
determining, for each of the classifications, a minimum distortion with use of a selected one of the subset of the trained convolutional neural network loop filters and a baseline distortion without use of any trained convolutional neural network loop filter; and
assigning, for each of the classifications, the selected one of the subset of the trained convolutional neural network loop filters in response to the minimum distortion being less than the baseline distortion for the classification or skip convolutional neural network loop filtering in response to the minimum distortion not being less than the baseline distortion for the classification.

45. The machine readable medium of claim 41, further comprising:
determining, for a coding unit of a second reconstructed video frame, a coding unit level distortion with convolutional neural network loop filtering on using a mapping table indicating which of the subset of the trained convolutional neural network loop filters are to be applied to blocks of the coding unit; and
flagging convolutional neural network loop filtering on in response to the coding unit level distortion being less than a coding unit level distortion without use of convolutional neural network loop filtering or off in response to the coding unit level distortion not being less than a coding unit level distortion without use of convolutional neural network loop filtering.

46. The machine readable medium of claim 41, wherein encoding the input video based at least in part on the subset of the trained convolutional neural network loop filters comprises:
receiving a luma region, a first chroma channel region, and a second chroma channel region;
determining expanded regions around and including each of the luma region, the first chroma channel region, and the second chroma channel region;
generating an input for the trained convolutional neural network loop filters comprising multiple channels including a first, second, third, and fourth channels corresponding to sub-samplings of pixel samples of the expanded luma region, a fifth channel corresponding to pixel samples of the expanded first chroma channel region, and a sixth channel corresponding to pixel samples of the expanded second chroma channel region;
applying the first trained convolutional neural network loop filter to the multiple channels.
